(19) United States
(12) Patent Application Publication
(10) Pub. No.: US 2026/0347020 A1
(43) Pub. Date: Nov. 5, 2026

(54) Dynamic Configuration Of A Gimbal System For A UAV

(71) Applicant: Skydio, Inc., San Mateo, CA (US)

(72) Inventors: Alexander David Savello, San Francisco, CA (US); Dominic William Pattison, San Mateo, CA (US); Patrick Allen Lowe, Palo Alto, CA (US); Christopher Michael Schwab, Woodside, CA (US); Gregory Ivan Edmund Balke, San Mateo, CA (US); Stepan Moskovchenko, Belmont, CA (US)

(21) Appl. No.: 18/776,210

(22) Filed: Jul. 17, 2024

Related U.S. Application Data
(60) Provisional application No. 63/527,271, filed on Jul. 17, 2023.

(51) Int. Cl. B64U 20/87; B64U 10/14; G03B 15/00; G05D 1/689; B64U 101/30

(52) U.S. Cl. CPC B64U 20/87; B64U 10/14; G03B 15/006; G05D 1/689; B64U 2101/30

(57) ABSTRACT

A system that includes an unmanned aerial vehicle (UAV) and a gimbal system removably coupled to the UAV. The gimbal system includes an image capture device configured to capture an image of an environment based upon a range of motion of the image capture device, a gimbal coupled to the image capture device and configured to articulate the image capture device, and a computing device in communication with the image capture device and the gimbal to operate the image capture device and the gimbal. The gimbal system is configured to automatically articulate the gimbal to increase a range of motion of the image capture device based upon one or more conditions.

### CROSS-REFERENCE TO RELATED APPLICATIONS

This application claims the benefit of U.S. Provisional Application Serial No. 63/527,271, filed on Jul. 17, 2023, the contents of which are incorporated herein by reference in their entirety.

### TECHNICAL FIELD

This disclosure relates to an unmanned aerial vehicle (UAV), and more specifically, to a gimbal system for a UAV.

### BACKGROUND

UAVs may include one or more image capture devices to capture pictures or videos during flight of the UAVs. Conventional image capture devices for UAVs are often large, mechanically complex, expensive, or a combination thereof. Additionally, conventional image capture devices for UAVs are often secured to the UAV in a manner that prohibits a full range of motion of the image capture devices or blocks a field of view of the image capture devices, thereby negatively impacting operation of the image capture devices and/or image quality captured by the image capture devices.

### SUMMARY

In one aspect of the present disclosure, a gimbal system of an unmanned aerial vehicle (UAV) is disclosed. The gimbal system includes a frame configured to removably couple the gimbal system to the UAV, a gimbal movably coupled to the frame and positioned within the channel of the frame, an image capture device movably coupled to the gimbal, and a computing device. The frame defines a channel therein. Additionally, the computing device includes a connector configured to removably couple and electrically connect the computing device to the UAV, a data storage device configured to store calibration data of the gimbal system, and a communications interface configured to transmit the calibration data to the UAV. The calibration data is usable to modify at least one of propulsion characteristics and flight characteristics of the UAV.

In certain embodiments, the frame includes a housing that defines an interior cavity of the frame. The computing device is located within the housing. Additionally, the connector extends through an opening of the housing to removably couple and electrically connect the computing device to the UAV.

In certain embodiments, the frame includes a planar portion coupled to and supported by a planar surface of the UAV such that the gimbal system is positioned in front of the UAV with respect to a longitudinal axis of the UAV that defines a forward direction of travel of the UAV.

In certain embodiments, wiring is routed through the frame and the gimbal to electrically connect the computing device and the image capture device.

In certain embodiments, the computing device is configured to control articulation of the gimbal and operation of the image capture device.

In certain embodiments, the connector is positioned within a cavity defined by the frame and the connector protrudes from the cavity to electrically connect the computing device to the UAV.

In certain embodiments, the calibration data is based on one or more characteristics of the gimbal system. Additionally, the calibration data is usable to modify at least one of the propulsion characteristics and the flight characteristics of the UAV during operation of the UAV if the calibration data changes based on operation of the gimbal system. The one or more characteristics correspond to at least one of: a weight of the gimbal system, operation characteristics of the gimbal, operation characteristics of the image capture device, a center of mass of the gimbal system, and one or more moments of inertia with respect to one or more axes of rotation of the gimbal system.

In certain embodiments, the gimbal system is configured to interchange with one or more additional gimbal systems. The calibration data of the gimbal system is different than additional calibration data associated with the one or more additional gimbal systems.

In certain embodiments, the gimbal includes one or more motors configured to articulate one or more arms of the gimbal about a respective axis of rotation defined by each of the one or more motors to rotate the image capture device in one or more degrees of freedom with respect to the UAV. The computing device is configured to control operation of the one or more motors.

In another aspect of the present disclosure, a gimbal system configured to removably couple to a UAV is disclosed. The gimbal system includes an image capture device, a gimbal coupled to the image capture device, and a computing device removably coupled and electrically connected to the UAV. The gimbal is configured to articulate the image capture device in three degrees of freedom with respect to the UAV. The computer device includes a data storage device and a communication interface. The data storage device is configured to store calibration data specific to one or more characteristics of the gimbal system and to update the calibration data based upon operation of the gimbal system. Additionally, the communication interface is configured to transmit the calibration data to the UAV to cause an adjustment to one or more flight characteristics of the UAV.

In certain embodiments, the gimbal includes one or more motors configured to articulate one or more arms of the gimbal to articulate the image capture device in the three degrees of freedom. Each of the one or more motors defines an axis of rotation of the image capture device. Additionally, the computing device is configured to control operation of the one or more motors to articulate the one or more arms and configured to control operation of the image capture device. Moreover, the gimbal includes a first motor defining a first axis of rotation of the image capture device, a second motor defining a second axis of rotation of the image capture device, and a third motor defining a third axis of rotation of the image capture device. The first axis of rotation, the second axis of rotation, and the third axis of rotation are substantially perpendicular to one another.

In certain embodiments, the computing device includes a connector. The connector removably couples and electrically connects the computing device to the UAV.

In certain embodiments, the computing device is configured to control operation of one or both of the image capture device or the gimbal based upon input received by the computing device from the UAV.

In another aspect of the present disclosure, a system is disclosed. The system includes a UAV, a gimbal system removably coupled to the UAV and configured to provide calibration data to the UAV to calibrate flight characteristics of the UAV, and a remote electronic device configured to communicate with, and control operation of, both the UAV and the gimbal system. The calibration data is based on one or more characteristics of the gimbal system.

In certain embodiments, the calibration data is stored on a computing device of the gimbal system. The computing device is configured to establish an electrical connection with the UAV to provide the calibration data to the UAV. Additionally, the computing device is configured to control operation of the gimbal system. Moreover, the computing device is mechanically coupled to the UAV to establish the electrical connection with the UAV. Furthermore, the gimbal system is configured for interchanging with an additional gimbal system having calibration data stored on a computing device of the additional gimbal system. The calibration data of the gimbal system is different than the calibration data of the additional gimbal system.

In certain embodiments, the gimbal system includes an image capture device configured to provide images or video to the remote electronic, a gimbal configured to articulate the image capture device, and a computing device in communication with the image capture device and the gimbal to operate both the image capture device and the gimbal. The remote electronic device is a user interface configured to generate and provide commands to the computing device.

In another aspect of the present disclosure, a method of initializing a gimbal system of a UAV to determine an initial position of an image capture device coupled to a gimbal of the gimbal system is disclosed. The method includes obtaining, via an inertial measurement unit (IMU) of the gimbal system, measurements of one or more parameters of the gimbal system. The method also includes determining, based upon a measurement obtained by a position sensor of the gimbal system, a rotational position of a motor of the gimbal with respect to an axis of rotation of the motor, and determining a possible position of the image capture device based upon the rotational position of the motor and the measurements. Responsive to determining the possible position, the method further includes determining whether the possible position is the initial position by comparing the possible position to the measurements.

In certain embodiments, the possible position is compared to the measurements to determine whether the possible position would result in the IMU obtaining the measurements for the one or more parameters.

In certain embodiments, responsive to determining that the possible position is the initial position, the method also includes establishing the possible position as the initial position, wherein the gimbal system is configured for calibration based on using the initial position as a starting position.

In certain embodiments, responsive to determining that the possible position is not the initial position, the method further includes determining one or more additional possible positions based upon the rotational position of the motor and the one or more parameters, and responsive to determining the one or more additional possible positions, determining whether one of the one or more additional possible positions is the initial position by comparing the one or more additional possible position to the measurements.

In certain embodiments, comparing the possible position to the measurements includes propagating the possible position based upon the measurements to predict how the possible position changes over time during operation of the gimbal system, during operation of the UAV, or both. Comparing the possible position to the measurements includes propagating the possible position based upon measurements obtained by a gyroscope of the IMU.

In certain embodiments, the position sensor is a Hall effect sensor configured to determine the rotational position of the motor based upon a rotational position of a stator of the motor compared to a rotor of the motor.

In certain embodiments, the method further includes determining, based on the measurements, a direction of gravity. Determining the direction of gravity is further based on measurements obtained by an accelerometer of the UAV, the accelerometer being separate from the IMU of the gimbal system.

In another aspect of the present disclosure, a gimbal system of a UAV is disclosed. The gimbal system includes a frame configured to removably couple the gimbal system to the UAV and a gimbal movably coupled to the frame. The gimbal includes an inertial measurement unit (IMU) configured to measure one or more parameters of the gimbal system, one or more arms configured to articulate in different degrees of freedom, and one or more motors configured to articulate a respective one of the one or more arms. Each of the one or more motors defines an axis of rotation for a respective one of the one or more arms. Additionally, each of the one or more motors includes a position sensor configured to determine a rotational position of a respective one of the one or more arms about a respective axis of rotation defined by the one or more motors, and articulation of the gimbal is based upon the rotational position determined for each of the one or more motors and the one or more parameters measured by the IMU.

In certain embodiments, each of the one or more motors includes a rotor coupled to or integrally formed with the respective one of the one or more arms. The rotor is configured to rotate about the respective axis of rotation to determine the rotational position and thereby rotate the respective one of the one or more arms about the respective axis of rotation.

In certain embodiments, the one or more parameters measured by the IMU includes at least one of: a specific force, an angular rate, and a magnetic field. Each of the one or more motors includes a stator at least partially surrounded by a respective rotor, and the rotational position is determined by the position sensor based upon rotation of the rotor with respect to the stator. Additionally, for each of the one or more motors, the position sensor is configured to determine a rotational position of the rotor with respect to the stator. Moreover, for each of the one or more motors, the stator defines a groove and the position sensor is disposed within the groove such that the position sensor is located adjacent to the rotor.

In certain embodiments, the position sensor is a Hall effect sensor.

In another aspect of the present disclosure, a system is disclosed. The system includes a UAV and a gimbal system removably coupled to the UAV to movably couple an image capture device to the UAV. The gimbal system includes an image capture device, an inertial measurement unit (IMU) configured to measure one or more parameters of the gimbal system, a first motor that defines a first axis of rotation for the image capture device and that includes a first position sensor configured to determine a first rotational position of the image capture device with respect to the first axis of rotation, a second motor that defines a second axis of rotation for the image capture device and that includes a second position sensor configured to determine a second rotational position of the image capture device with respect to the second axis of rotation, and a third motor that defines a third axis of rotation for the image capture device and that includes a third position sensor configured to determine a third rotational position of the image capture device with respect to the third axis of rotation. The image capture device is configured to move in three degrees of freedom based upon rotation of the image capture device about the first axis of rotation, the second axis of rotation, and the third axis of rotation, and movement of the image capture device is based upon the first rotational position, the second rotational position, the third rotational position, and the one or more parameters measured by the IMU.

In certain embodiments, the system further includes a computing device removably coupled and electrically connected to the UAV. The first position sensor, the second position sensor, and the third position sensor are configured to transmit a position of the image capture device with respect to the UAV to the computing device as position information. The position information transmitted to the computing device includes a relative position of the image capture device with respect to the UAV in each of the three degrees of freedom. Additionally, the system may also include a remote electronic device configured to communicate with, and control operation of, both the gimbal system and the UAV. The remote electronic device is configured to control operation of the gimbal system based upon the first rotational position, the second rotational position, and the third rotational position.

In another aspect of the present disclosure, a system is disclosed. The system includes a UAV and a gimbal system removably coupled to the UAV. The gimbal system includes an image capture device configured to capture an image of an environment based upon a range of motion of the image capture device, a gimbal coupled to the image capture device and configured to articulate the image capture device, and a computing device in communication with the image capture device and the gimbal to operate the image capture device and the gimbal. The gimbal system is configured to automatically articulate the gimbal to increase a range of motion of the image capture device based upon one or more conditions.

In certain embodiments, the gimbal system is configured to automatically articulate the gimbal when the image capture device reaches a predefined position.

In certain embodiments, the gimbal includes a motor having a position sensor configured to determine a rotational position of the motor with respect to an axis of rotation. Additionally, the gimbal system is configured to automatically articulate the gimbal when the motor reaches a predefined position. Moreover, the gimbal system is configured to automatically rotate the motor about 180 degrees with respect to the axis of rotation to flip the rotational position of motor and thereby increase the range of motion of the image capture device.

In certain embodiments, the gimbal system is configured to automatically articulate the gimbal when the image capture device is prevented from reaching a desired position to capture the image of the environment.

In certain embodiments, the computing device is configured to determine whether the one or more conditions for automatically articulating the gimbal are met.

In certain embodiments, the system further includes a remote electronic device configured to communicate with the computing device to display the image captured by the image capture device. A user is configured to initiate automatically articulating the gimbal via the remote electronic device. Moreover, the remote electronic device or at least one of the UAV and the gimbal system prior is configured to automatically flip the image approximately 180 degrees when the gimbal system automatically articulates the gimbal.

In certain embodiments, the UAV is configured to operate autonomously to complete a scan mode, and the gimbal system is configured to automatically articulate the gimbal during the autonomous operation.

In another aspect of the present disclosure, a system is disclosed. The system include a UAV configured for autonomous flight based upon a predefined scan path and a predefined scan schedule. The system also includes a gimbal system removably coupled to the UAV. The gimbal system includes an image capture device configured to articulate based upon a range of motion, a gimbal coupled to the image capture device and configured for automatic articulation by the gimbal system during autonomous flight of the UAV to increase the range of motion of the image capture device, and a computing device in communication with the image capture device and the gimbal to operate the image capture device and the gimbal. Responsive to the gimbal system automatically articulating the gimbal, at least one of the UAV and the computing device is configured to correct an image captured by the image capture device prior to transmitting the image to a remote electronic device that is configured to display the image.

In certain embodiments, the remote electronic device is configured to communicate with the computing device to display the image on a display of the remote electronic device. At least one of the UAV and the computing device is configured to correct an orientation of the image transmitted to the remote electronic device when the gimbal system automatically articulates the gimbal. Moreover, at least one of the UAV and the computing device is configured to correct the image by modifying an orientation of the image displayed by the remote electronic device prior to the remote electronic device displaying the image. Additionally, the gimbal system is configured to automatically rotate the image capture device approximately 180 degrees about an axis of rotation, and at least one of the UAV and the computing device is configured to rotate the image approximately 180 degrees in response to rotating the image capture device.

In certain embodiments, the gimbal system is configured to determine an orientation of the image capture device based upon data captured by a position sensor of the gimbal. The data captured by the position sensor is a rotational position of a motor of the gimbal, and the orientation of the image capture device is based upon the rotational position of the motor.

In another aspect of the present disclosure, a system is disclosed. The system includes a UAV, a gimbal system removably coupled to the UAV, and a remote electronic device in wireless communication with at least one of the UAV and the gimbal system and configured to display the image. The gimbal system includes an image capture device configured to capture an image and a gimbal coupled to the image capture device and configured to articulate the image capture device. The gimbal system is configured to automatically articulate the gimbal to move the image capture device from an upright position, in which the image capture device captures the image in a natural viewing position, to a flipped position, in which the image capture device is rotated about 180 degrees with respect to an axis of rotation. Additionally, responsive to the gimbal system automatically articulating the gimbal to move the image capture device from the upright position to the flipped position, the remote electronic device is configured to rotate the image in real-time when displaying the image such that the image is displayed as if the image were captured in the natural viewing position.

In certain embodiments, the image is a video configured for displaying as a live feed by the remote electronic device, and rotation of the image is done in real-time such that a user viewing the image on the remote electronic device is unable to notice the rotation of the image. Moreover, the computing device includes a communication interface configured to transmit an orientation of the image capture device to the remote electronic device, and the remote electronic device is configured to rotate the image based upon receiving the orientation of the image capture device.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an exemplary UAV having a gimbal system.

FIG. 2 is a perspective view of a gimbal system of a UAV.

FIG. 3 is a side view of a gimbal system of a UAV.

FIG. 4 is a rear perspective view of a gimbal system of a UAV.

FIG. 5 is a close-up view of the gimbal system of FIG. 4.

FIG. 6 is a partially exploded view of a gimbal system of a UAV.

FIG. 7A is a side view of a gimbal system illustrating articulation of the gimbal system.

FIG. 7B is a close-up view of a first motor of the gimbal system of FIG. 7A.

FIG. 7C is a close-up view of a second motor of the gimbal system of FIG. 7A.

FIG. 7D is a close-up view of a third motor of the gimbal system of FIG. 7A.

FIG. 8 is an exploded view of the third motor of a gimbal system of a UAV.

FIG. 9 is a diagram of a network configuration for a UAV.

FIG. 10 is a flowchart of an example of a process for installing and operating a gimbal system of a UAV.

FIG. 11 is a flowchart of an example of a process for interchanging gimbal systems of a UAV.

FIG. 12 is a flowchart of an example of a process for initiating an autonomous scan mode of a UAV.

FIG. 13 is a block diagram of an example of a hardware configuration of a gimbal system of a UAV.

FIG. 14A is a perspective view of a gimbal system of a UAV having an image capture device in an upright position.

FIG. 14B is a perspective view of the gimbal system of FIG. 14B having the image capture device in a flipped position.

FIG. 15 is a flowchart of another example of a process for operating a gimbal system of a UAV.

### DETAILED DESCRIPTION

Conventional image capture devices for UAVs may often be fixed to the UAV, thereby preventing movement of the image capture devices with respect to the UAV. Additionally, conventional image capture devices may also often be movably coupled to the UAV in a manner that requires mechanically complex structures and/or may require permanent coupling of the image capture device to the UAV. As a result, replacement or interchangeability of the image capture device may be difficult. Similarly, the complex structure coupling the image capture device to the UAV may obstruct and/or hinder operation of the image capture device. For example, the image capture device may be coupled to the UAV in a manner that obstructs a portion of a field of view of the image capture device, thereby hindering the quality of images captured by the image capture device.

The present disclosure relates to a gimbal system of a UAV. The gimbal system may include an image capture device configured to capture images and/or videos. The gimbal system may be removably coupled to the UAV. The gimbal system may be in electrical communication with the UAV. The gimbal system may include one or more movable components that facilitate movement of the image capture device. By way of example, certain configurations of the gimbal system may include one or more motors that are configured to articulate one or more arms of the gimbal system, thereby moving the image capture device.

The present teachings provide embodiments of a gimbal system which address the aforementioned challenges as described in further detail below. The gimbal system embodiments as described herein may advantageously be less complex mechanically when compared to conventional mechanics used to couple image capture devices to a UAV. Additionally, the gimbal system embodiments described herein may provide a means for replacement and/or interchangeability with one or more additional gimbal systems, one or more additional image capture devices, or both. Similarly, the gimbal system embodiments described herein may facilitate removably coupling the image capture device to the UAV. For example, the gimbal system – and thus the image capture device – according to the embodiments herein may be easily connected and disconnected from the UAV. Moreover, the gimbal system may have improved packaging for coupling the image capture device to the UAV. For example, the gimbal system may have a simpler design that facilitates movable operation of the image capture device with respect to the UAV yet may not obstruct a field of view of the image capture device. That is, the gimbal system as described herein may be free of obstructing the field of view of the image capture device even when moving the image capture device. As such, the gimbal system as described herein may improve and/or increase a field of view of the image capture device.

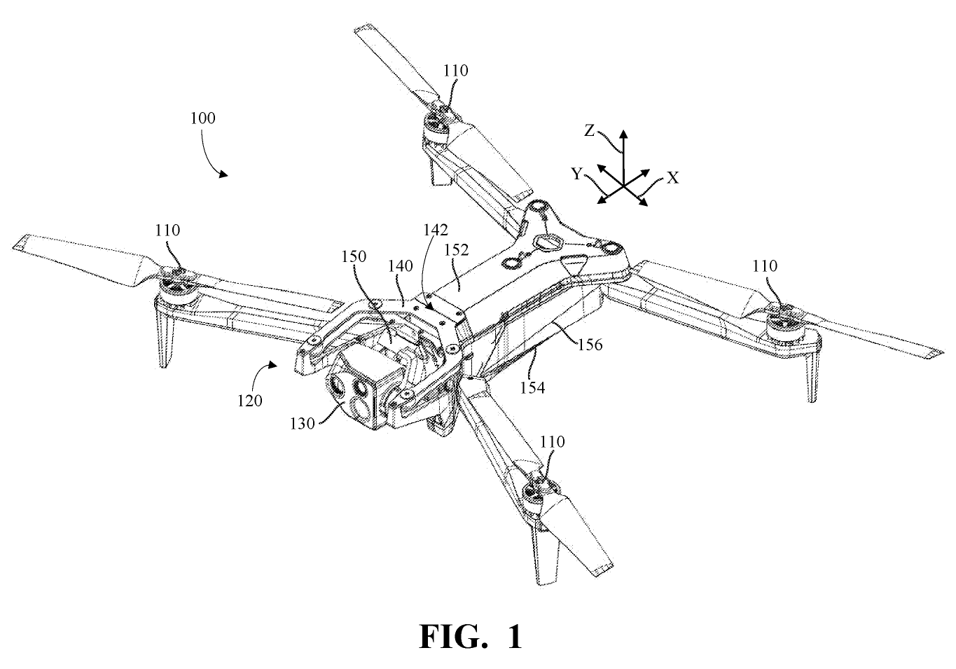

Turning now to the figures, FIG. 1 illustrates a perspective view of an unmanned aerial vehicle (UAV) 100. The UAV 100 may include one or more propulsion mechanisms (systems) 110 and a power source, such as a battery. The UAV 100 may be configured for autonomous flight, landing (e.g., docking) on a docking station, or both. To support the autonomous flight and landing, the UAV 100 may follow any suitable process or procedure and may include any suitable electrical and/or logical components. For example, the UAV 100 may follow processes or procedures, or may include one or more components, such as those described in U.S. Publication No. 16/991,122, the entire disclosure of which is herein incorporated by reference.

The propulsion mechanism(s) 110 may include any components and/or structures suitable for supporting flight of the UAV 100. For example, as shown in FIG. 1, the propulsion mechanism(s) 110 may be propeller assemblies having one or more blades connected to hubs of the UAV 100. The one or more blades may be powered by a motor to rotate the one or more blades and facilitate flight of the UAV 100. It should be appreciated, however, that the configuration and/or structure of the UAV 100 may vary depending on the particular UAV, and as such, the UAV 100 shown in FIG. 1 is not intended to limit the structure of the UAV 100.

The UAV 100 may also include one or more attachments coupled to the UAV 100. For example, as shown in FIG. 1, a gimbal system 120 may be coupled to the UAV 100. A frame 140 of the gimbal system 120 may be secured to the UAV 100 so that an image capture device 130 of the gimbal system 120 may be movably coupled to the UAV 100. That is, the gimbal system 120 may include a gimbal 150 that is configured to move the image capture device 130 in one or more degrees of motion. As a result, the gimbal 150 may be operable to capture images and/or videos during flight of the UAV 100, prior to flight of the UAV 100, after flight of the UAV 100, or a combination thereof. That is, the gimbal system 120 may be operable in conjunction with flight of the UAV 100 or the gimbal system 120 may be operable independently of flight of the UAV 100.

The gimbal system 120 may be coupled to various portions of the UAV 100. For example, the gimbal system 120 may be coupled to a front portion of the UAV 100 such that the gimbal system 120 is located in front of a body of the UAV 100 with respect to a longitudinal axis (Y) of the UAV 100. That is, the longitudinal axis (Y) may be a fore-aft direction of travel (e.g., forwards and backwards) such that the gimbal system 120 may be located in front of the UAV 100 when the UAV 100 travels forward.

While the gimbal system 120 shown in FIG. 1 is coupled to the front portion of the UAV 100, it should be noted that attachment of the gimbal system 120 to the UAV 100 is not particularly limited to any one location of the UAV 100. For example, the gimbal system 120 may be mounted to a side of the UAV 100 such that the gimbal system 120 is positioned in front of the UAV 100 when the UAV 100 travels in a lateral direction along a transverse a lateral axis (X) of the UAV 100 and/or the gimbal system 120 may be mounted to a top or bottom of the UAV 100 such that the gimbal system 120 is positioned in front of the UAV 100 when the UAV 100 travels in an elevational direction along an elevational axis (Z) of the UAV 100. Thus, the gimbal system 120 may be coupled to a rear, top, bottom, front, or side of the UAV 100 depending on a desired configuration. However, it is envisioned that the gimbal system 120 may advantageously couple to the UAV 100 in a manner that does not obstruct the propulsion mechanism(s) 110 of the UAV 100 to allow for movement of the UAV 100 in the longitudinal direction (e.g., along the longitudinal axis (Y)), in the lateral direction (e.g., along the lateral axis (X)), and in the elevational direction (e.g., along the elevational axis (Z)).

As discussed above, the frame 140 of the gimbal system 120 may be coupled to the UAV 100 to movably couple the image capture device 130 to the UAV 100 (e.g., a body of the UAV 100). The frame may abut one or more surfaces of the UAV 100 such that the frame may be coupled to the one or more surfaces of the UAV 100. For example, the frame 140 may extend along an upper, planar surface of the UAV 100. The upper, planar surface may be a top surface 152 of the UAV 100 based upon the elevational axis (Z). A surface of the frame 140 may be flush or otherwise complementary in shape to the top surface 152 of the UAV 100 such that, when the frame 140 is coupled to the UAV 100 (e.g., via one or more fasteners), all or a portion of the frame 140 may be supported by the top surface 152 of the UAV 100. For example, the frame 140 may include a planar portion 142 that extends along or parallel to the longitudinal axis (X) of the UAV 100. The planar portion 142 of the frame 140 may be supported by and coupled to the top surface 152 of the UAV 100. The top surface 152 may be planar such that the planar portion 142 of the frame 140 is substantially or entirely supported by the top surface 152 of the UAV 100.

In certain configurations, the top surface 152 of UAV 100 may include one or more nonplanar portions, which may abut complementary nonplanar portions of the frame 140. Additionally, it should be noted that the frame 140 may also be coupled to an opposing bottom surface 154 of the UAV 100 and/or a side surface 156 of the UAV 100 to provide further customization of the UAV 100.

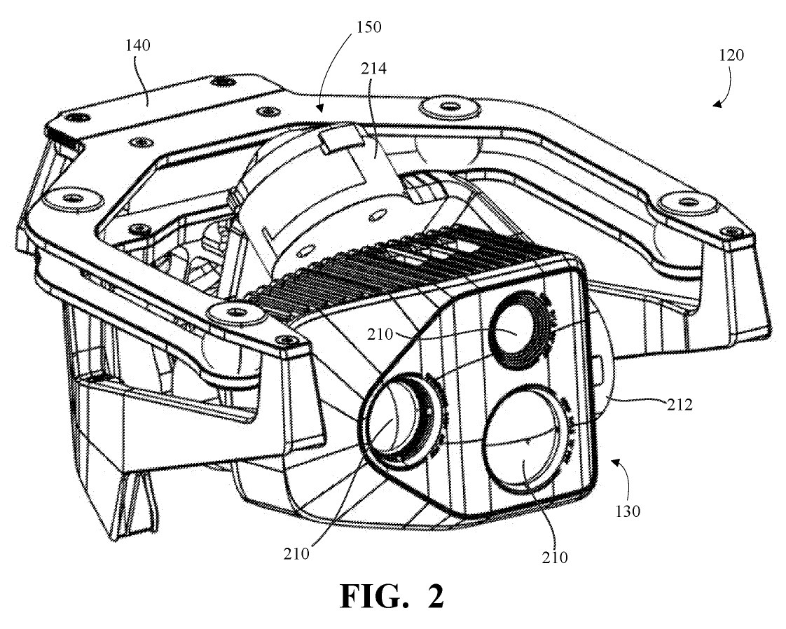

FIG. 2 illustrates a perspective view of the gimbal system 120. As discussed above, the gimbal system may include an image capture device 130 movably coupled to the frame 140 of the gimbal system 120 by the gimbal 150. The frame 140 may be coupled to the UAV 100 in any desired manner, such as by one or more fasteners, one or more mechanical interlocks, or both. However, it is envisioned that the frame 140 may removably couple the gimbal system 120 to the UAV 100 to facilitate easy connection and disconnection of the gimbal system 120 with respect to the UAV 100. Furthermore, the removable coupling of the gimbal system 120 to the UAV 100 may allow for interchangeability between different gimbal systems. By way of example, the gimbal system 120 may be interchanged with an additional gimbal system that includes one or more different attachments, such as a different image capture device (e.g., night-vision camera, infrared camera, etc.) or a different device (e.g., a probe, a light detection and ranging device (LIDAR), etc.). Thus, the gimbal system 120 described herein may allow for easy customization of the UAV 100 depending on the desired operation of the UAV 100.

As discussed above, the image capture device 130 of the gimbal system 120 may be configured to capture images and/or video. The image capture device 130 may include one or more image sensors 210 to capture the images and/or video. By way of example and as shown in FIG. 2, the image capture device 130 may include three image sensors 210. The image sensors 210 may be a wide-angle camera or a narrow-angle camera. A wide-angle camera may be considered a camera having a wider field of view (e.g., a field of view greater than about 90 degrees) while a narrow-angle camera may be considered a camera having a narrow field of view (e.g., a field of view less than about 90 degrees). The image sensors 210 may be a thermal camera (e.g., a radiometric camera or a non-radiometric camera) that may be configured to detect infrared radiation emitted by objects and capture images thereof, which may be processed to create a thermographic image that illustrates thermal patterns and temperature distributes within the environment captured within the image. The image sensors 210 may also be a telephoto camera to facilitate capturing images of distance objects with greater magnification and/or clarity.

The image capture device 130 is not particularly limited to any one type of image sensor, and thus various configurations of the image capture device 130 may be possible based on the teachings herein. By way of example, any combination of the aforementioned camera may be present in the image capture device 130. For example, the image capture device 130 may include a narrow-angled camera, a telephoto camera, and a thermal camera. Alternatively, the image capture device 130 may include a wide-angled camera, a telephoto camera, and a thermal camera. Similarly, the image capture device 130 may include a wide-angled camera, a telephoto camera, and a narrow-angled camera. Moreover, the image capture device 130 may include or be in communication with additional accessories. For example, the image capture device may include a flashlight to illuminate a surrounding area to aid in accurately capturing images of the surround area. Additionally, in certain embodiments, the gimbal system 120 as described herein may be configured to couple other types of devices to the UAV 100, which may be in communication with the image sensors 210 of the image capture device 130.

The gimbal system 120 may movably couple the image capture device 130 to the UAV 100. The gimbal 150 may facilitate movement of the image capture device 130. The gimbal 150 may couple the image capture device 130 to the frame 140, thereby coupling the image capture device 130 to the UAV 100. As shown in FIG. 2, the gimbal 150 may be disposed generally in a central region of the gimbal system 120 that is at least partially surrounded by the frame 140. That is, the frame 140 may define a channel and the gimbal 150 may be partially or entirely disposed in the channel. The gimbal 150 may extend beyond the confines of the frame (e.g., beyond the confines of the channel of the frame 140) before, during, or after operation of the gimbal 150 (e.g., movement of the image capture device 130 and/or movement of the gimbal 150 to maintain a position and/or orientation of the image capture device 130). The frame 140 may be configured to stabilize the gimbal system 120 during operation. For example, the frame 140 may prevent unwanted rattling of the gimbal system 120 with respect to the UAV 100 during movement of the gimbal 150 and the image capture device 130.

The gimbal 150 may include one or more motors that are configured to articulate one or more arms of the gimbal 150. As shown in FIG. 2, the gimbal 150 may include a first motor 212 coupled to the image capture device 130 and a second motor 214 coupled to arms of the gimbal 150. The first motor 212 and the second motor 214 may facilitate substantially free-range movement of the image capture device 130 with respect to the frame 140 free of obstruction from the frame 140 and free of obstruction from the UAV 100. Similarly, the operation of the gimbal 150 may allow for a substantially full range of motion of the image capture device 130 without obstruction of a field of view of the image capture device 130 by the frame 140, the gimbal 150, or the UAV 100. As discussed below, the gimbal 150 may facilitate one or more degrees of freedom of movement of the image capture device 130.

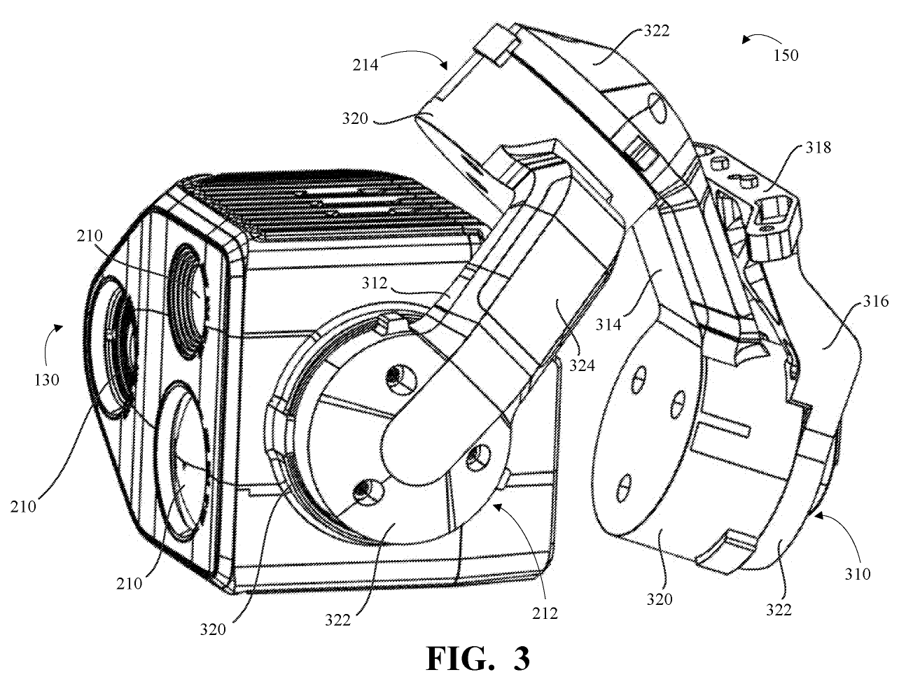

FIG. 3 is a side view of the gimbal system 120. The frame 140 has been omitted from the view for illustrative purposes. However, it should be noted that in certain configurations, the frame 140 may be interchangeable or the gimbal system 120 may be mounted to the UAV without the frame 140.

As discussed above, the gimbal system 120 may include the image capture device 130 movably coupled to the gimbal 150. The gimbal 150 may include the first motor 212 coupled to the image capture device 130, the second motor 214 coupling a first arm 312 of the gimbal 150 to a second arm 314 of the gimbal 150, and a third motor 310 coupling the second arm 314 to a third arm 316 of the gimbal 150. Each of the motors 212, 214, 310 may include a rotor 320 and a stator 322. While the motors 212, 214, 310 may be any type of motor (e.g., AC motor, DC motor, brushless motor, stepped motor, etc.) with any configuration of the rotor 320 and the stator 322, communication between the rotor 320 and the stator 322 may facilitate movement within the gimbal system 120. By way of example, the first motor 212 may function to pitch the image capture device with respect to an axis of rotation of the first motor 212. Similarly, the first arm 312 may be configured to pivot about an axis of rotation of the second motor 214 and the second arm 314 may be configured to pivot about an axis of rotation of the third motor 310. However, depending on the structure and geometry of the arms 312, 314, 316, various articulation envelopes may be possible.

The third arm 316 of the gimbal 150 may also include an attachment portion 318. The attachment portion 318 may be configured to couple the gimbal 150 to the frame 140 of the gimbal system 120. Advantageously, the attachment portion 318 may be easily disconnected from, and connect to, the frame 140 to allow for even further customization, interchangeability, and replacement of various components within the gimbal system 120 (e.g., the image capture device 130, the gimbal 150, etc.). For example, as discussed in further detail below, wiring may be routed through the gimbal 150 (e.g., through the arms 312, 314, 316 of the gimbal 150) to reach each of the motors 212, 214, 310 and the image capture device 130 for operation of the motors 212, 214, 310 and the image capture device 130. Such wiring may also be routed through the frame 140 of the gimbal system 120 in order to connect the wiring of the gimbal system 120 with the UAV 100. The attachment portion 318 of the third arm 316 may allow for connection and disconnection without damaging the wiring of the gimbal system 120 or the UAV 100. Similarly, some or all of the arms 312, 314, 316 may include a cover 324 that permits access to an inner cavity of the arms 312, 314, 316 which may contain the wiring. Thurs, the wiring may be accessed in various locations within the gimbal system 120 to accommodate repairs, installation, replacement, or a combination thereof.

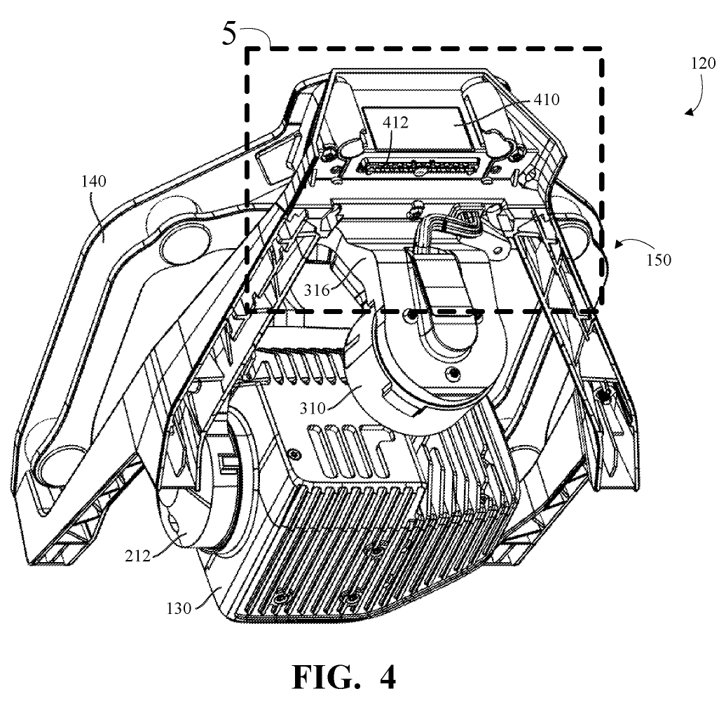

FIG. 4 illustrates a rear perspective view of the gimbal system 120. As discussed above, the gimbal system 120 may include the image capture device 130 movably coupled to the gimbal 150, whereby the gimbal 150 is movably coupled to the frame 140 of the image capture device 130. The frame 140 of the gimbal system 120 may be configured to removably couple the gimbal system 120 to the UAV 100.

The gimbal system 120 may also include a computing device 412. The computing device 412 may be configured to control one or more operations of the gimbal system 120. For example, the computing device 412 may be configured to control articulation of the gimbal 150, the image capture device 130, or both. The computing device 412 may also be configured to control operation of the image capture device 130 (e.g., control image and/or video capture by the image capture device 130). As discussed in further detail below, the computing device 412 may be configured to store data (e.g., calibration data related to the gimbal system 120), provide information to the UAV 100 or a computing system thereof (e.g., an electronic architecture of the UAV 100 configured to operate the UAV), receive information from the UAV 100 or the computing system thereof, or a combination thereof.

The computing device 412 of the gimbal system 120 may be configured to communicate with the UAV 100 via a wired connection or wirelessly. For example, the computing device 412 of the gimbal system 120 may be connected to the UAV 100 or the computing system thereof. Advantageously, the computing device 412 may be configured to removably couple and electrically connect to the UAV 100. That is, the computing device 412 may facilitate an electrical connection between the gimbal system 120 and the UAV 100 yet may still allow for easy installation and/or disconnection of the gimbal system 120 with respect to the UAV 100.

The computing device 412 may also be configured to communicate with one or more additional components. As discussed in further detail below, the computing device 412 may be configured to communicate with a user interface (e.g., a remote device) in wireless communication with the gimbal system 120 either directly or through a connection between the user interface and the UAV 100. That is, the gimbal system 120 may be electrically connected to the UAV 100, and thus the gimbal system 120 may be in communication with the user interface via the UAV 100.

The computing device 412 may be configured to operate the gimbal 150, the image capture device 130, or both via a wired connection. For example, the computing device 412 may be disposed in a housing 410 of the frame 140 and may be connected to the image capture device 130, the gimbal 150, or both by wiring routed through the frame 140, routed through the gimbal 150, routed through the image capture device 130, or a combination thereof. As a result, the computing device 412 may provide a signal to the image capture device 130 and/or the gimbal 150 to articulate the image capture device 130 and/or the gimbal 150, to operate the image capture device 130, or both. Similarly, images and/or video captured by the image capture device 130 may be provided (e.g., transmitted) to the computing device 412, at which point the computing device 412 may provide the images and/or video captured to the UAV 100, to an external device such as the user interface, or both. Thus, is should be noted that the embodiments herein are not limited to any specific communication between the computing device 412 and the gimbal system 120 or any specific communication between the computing device 412 and the UAV 100. Additionally, while the computing device 412 is discussed in further detail below, the embodiments herein are not particularly limited to any configuration of the computing device 412. For example, the computing device may include one or more processors, one or more memory storage devices, one or more controllers, one or more printed circuit board assemblies (PCBAs), one or more additional components, or a combination thereof.

As discussed above, the computing device 412 may be disposed in the housing 410 of the frame 140. The housing 410 may define an interior cavity of the frame 140. The housing 410 may be located anywhere along the frame 140 and may at least partially form a void in the frame 140 such that the computing device 412 is located in the housing 410. The computing device 412 may be partially or entirely enclosed by the housing 410. The housing 410 may include one or more openings to facilitate a removable, electrical connection between the computing device 412 and the UAV 100. The housing 410 may prevent debris and/or moisture from entering the housing 410 and damaging the computing device 412.

The housing 410 may be positioned along the frame 140 to facilitate connection between the computing device 412 and the UAV 100. For example, the housing 410 may be located near a rear end or rear portion of the frame 140 so that a portion of the computing device 412 (e.g., a connection portion of the computing device 412) may abut the UAV 100 when the gimbal system 120 is connected to the UAV 100. Thus, the housing 410 may position the computing device 412 in a position with respect to the UAV 100 so that connection and disconnection between the computing device 412 and the UAV 100 is completed easily without requiring significant time, thereby facilitating interchangeability between various gimbal systems. That is, the gimbal system 120 may be connected to, or disconnected from, the UAV 100 without requiring permanent modification to the UAV 100 or an electrical system thereof. Thus, the gimbal system 120 may be self-contained so that the electrical and mechanical systems are disposed in the confines of the gimbal system 120. For example, as discussed above, the wiring may be routed through the arms 312, 314, 316 of the gimbal 150, through the motors 212, 214, 310 of the gimbal 150, or both.

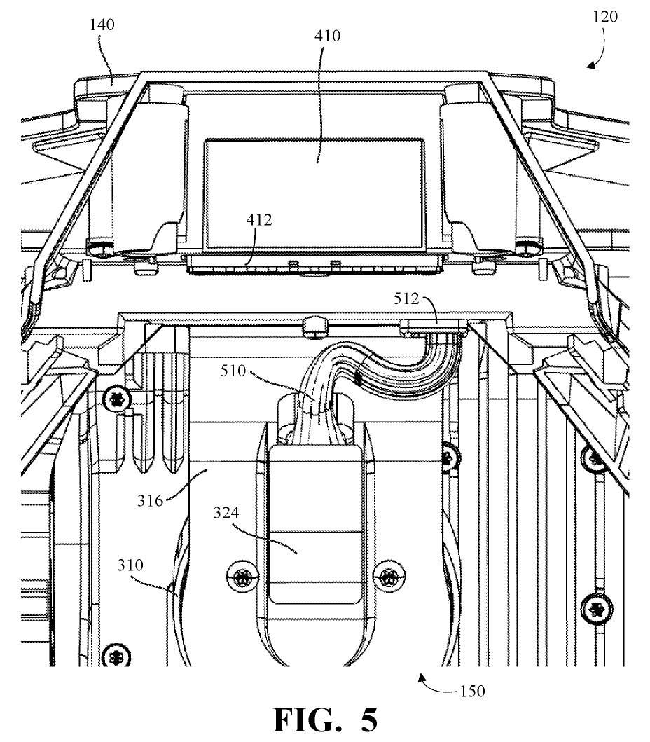

FIG. 5 illustrates close-up view 5 of FIG. 4. As illustrated, the computing device 412 at least partially protrude from an opening of the housing 410 of the frame to facilitate connection between the computing device 412 and the UAV 100. The housing 410 may be positioned along a rear portion of the frame 140 adjacent to gimbal 150 of the gimbal system 120, or a component thereof, such as the third motor 310.

As mentioned above, wiring 510 may be connected to the computing device 412 and may be routed through the gimbal 150 and/or the image capture device 130 to electrically connect the computing device 412, the gimbal 150, and the image capture device 130. The wiring 510 may be routed through a port 512 of the frame 140 that is configured to permit access to the interior cavity of the housing 410 so that the wiring 510 may be connected to the computing device 412 within the housing 410. The port 512 may be positioned adjacent to the housing 410, may be an opening of the housing 410 (e.g., the opening of the housing 410 that facilitates connection between the computing device 412 and the UAV 100). The port 512 may be coupled to the frame 140 and/or the housing 410, may be integrally formed with the frame 140 and/or the housing 410, or both. The port 512 may be or may include a grommet, bushing, cover, or a combination thereof to permit routing the wiring 510 through the port 512 yet prevent debris and/or moisture from entering the frame 140 and/or the housing 410 through the port 512.

The wiring 510 may be connected to the computing device 412 and may be routed through at least portions of the gimbal system 120, such as the frame 140, the image capture device 130, the gimbal 150, or a combination thereof. The wiring 510 may be routed through the gimbal 150 to power and/or control the motors 212, 214, 310, the image capture device 130, or a combination thereof. Advantageously, all or a portion of the gimbal 150 may include a channel or cavity disposed therein that facilitates routing of the wiring 510 through the gimbal 150 without all or a portion of the wiring 510 being exposed external of the gimbal system 120. By way of example, as shown in FIG. 5, the wiring 510 may be routed through the third arm 316 to connect to the third motor 310. The third arm 316 may include a cover 324 that permits at least partial access to an internal channel of the third arm 316 that contains the wiring 510 being routed to the third motor 310.As a result, the cover 324 may provide access to the wiring 510 within the third arm 316 for ease of connecting the wiring 510 to the third motor 310, replacement of the wiring 510, repair of the wiring 510, or a combination thereof. It should also be noted that similar routing of the wiring 510 may be done with respect to the first arm 312 and the first motor 212, the second arm 314 and the second motor 214, or a combination thereof. For example, the first arm 312 and the second arm 314 may each also include a cover similar or the same as the cover 324 shown in FIG. 5.

It should also be noted that all or only a portion of the wiring 510 may be connected to the computing device 412 of the gimbal system 120. For example, a portion of the wiring 510 may bypass connection to the computing device 412 and may be directly or indirectly connected to a power source configured to power the image capture device 130 and/or the gimbal 150 (e.g., power the motors 212, 214, 310 of the gimbal 150). The power source may be disposed or coupled to the gimbal system 120 as a dedicated power source for the gimbal system 120. The power source may also be a power source of the UAV 100, such as a battery of the UAV 100, that is configured to both power the UAV 100 and the gimbal system 120. In such a case, the wiring 510 may be connected to wiring of the UAV 100 – directly or through the computing device 412 – to receive power from the power source of the UAV 100.

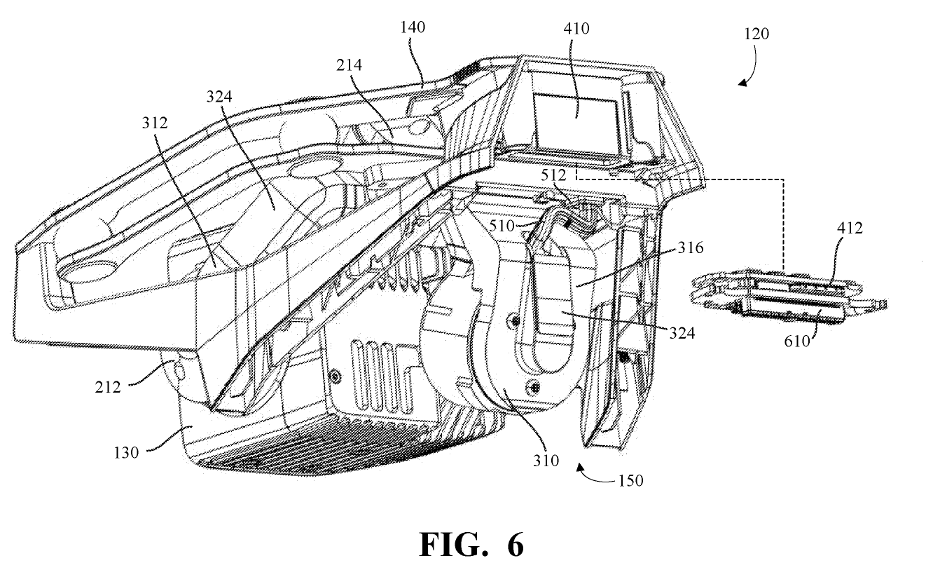

FIG. 6 is a partially exploded view of the gimbal system 120 having the computing device 412 removed from the housing 410 of the frame 140. As illustrated in FIG. 6 and discussed above, the gimbal system 120 may be configured removably couple to the UAV 100 via the frame 140 and the computing device 412. That is, the frame 140 may mechanically couple to the UAV 100 and the computing device 412 may electrically connect to the UAV 100. As a result, the image capture device 130 and/or the gimbal 150 may be in communication with the UAV 100 via the computing device 412.

As discussed above, the computing device 412 may be at least partially disposed in the housing 410 of the frame 140. The computing device 412 may protrude from the housing 410 through an opening of the housing 410 to removably couple and electrically connect to the UAV 100. The computing device 412 may include a connector 610 configured to removably couple and electrically connect the computing device 412 to the UAV 100 or an electrical system therein, such as the propulsion mechanism(s) 110 of the UAV 100, a power system of the UAV 100, or other electrical system of the UAV 100.

The connector 610 may extend through the opening of the housing 410 or may otherwise be exposed in the housing 410 of the frame 140 to facilitate connection between the connector 610 and the UAV 100. In certain embodiments, the connector 610 may be hardwired directly to wiring of the UAV 100 to create the electrical connection between the gimbal system 120 and the UAV 100. However, it is envisioned that, in order to maintain the removable coupling between the gimbal system 120 and the UAV 100 to facilitate interchangeability of the gimbal system 120 with other gimbal systems (or other attachments of the UAV 100), the connector 610 may be a quick connector that may connect to a connector of the UAV 100, thereby allowing for easy connection and disconnection between the connector 610 and the connector of the UAV 100. The connector 610 is not limited to any specific type of connector, and the connector 610 may be configured for any desired wiring scheme of the UAV 100 and/or the gimbal system 120. For example, the connector 610 may facilitate connection between the UAV 100 and the computing device 412 for high-voltage wiring, low-voltage wiring, or both. As a result, the computing device 412 may connect the wiring 510 of the gimbal system 120 to the gimbal 150 (e.g., the motors 212, 214, 310) and/or the image capture device 130 with the wiring of the UAV 100.

The connector 610 may include one or more male portions (e.g., pins), one or more female portions (e.g., ports), or a combination thereof. The connector 610 may facilitate connection between any desired number of wires. The connector 610 may include one or more mechanical interlocks that may engage the UAV 100 or a connector of the UAV 100. The connector 610 may be threated onto the UAV 100 or the connector of the UAV 100. The connector 610 may be removably coupled to the UAV 100 or the connector of the UAV 100 using one or more fasteners, one or more adhesives, or both. However, it is envisioned that coupling of the connector 610 may be done in a manner that allows for easy disconnect of the connector 610 free of damage to the connector 610 or the UAV 100. For example, the connector 610 may be connected to, and disconnected from, the UAV 100 free of tools.

It certain embodiments based on the teachings herein, the computing device 412 via the connector 610 may provide a single point of electrical connection between the gimbal system 120 and the UAV 100 (e.g., through the connector 610). As a result, the gimbal system 120 may provide a self-contained and modular attachment for the UAV 100. As discussed in further detail below, due to the modularity and interchangeability of the gimbal system 120, the gimbal system 120 may store and provide data pertaining to the gimbal system 120 on the computing device 412 therein, thereby eliminating the need to store such data in the UAV 100. For example, if a plurality of gimbal systems having varying configurations and specifications were each configured to attach to the UAV 100, conventional UAV systems may store calibration data for each of the gimbal systems in a computing device of the conventional UAV systems. However, the teachings herein may advantageously store such calibration on the gimbal system 120 or any alternative variation of the gimbal system 120 without needing to keep such information on the computing device of the UAV 100. As a result, the gimbal system 120 may facilitate easy connection and disconnection from the UAV 100. It should be noted that each interchangeable gimbal system may communicate with the UAV 100 such that flight characteristics and/or operating characteristics of the UAV 100 may be dynamically adjusted based on a particular gimbal system coupled to the UAV 100.

While the connector 610 has been described herein as a means of electrically connecting the gimbal system 120 to the UAV 100, in certain embodiments, the gimbal system 120 may be wireless connected to the UAV 100. For example, the gimbal system 120 may include a dedicated power source (e.g., a battery) coupled to the gimbal system 120 (e.g., the frame 140 of the gimbal system 120), and the gimbal system 120 may be configured to mechanically couple to the UAV 100 yet wirelessly communicate with the UAV 100.

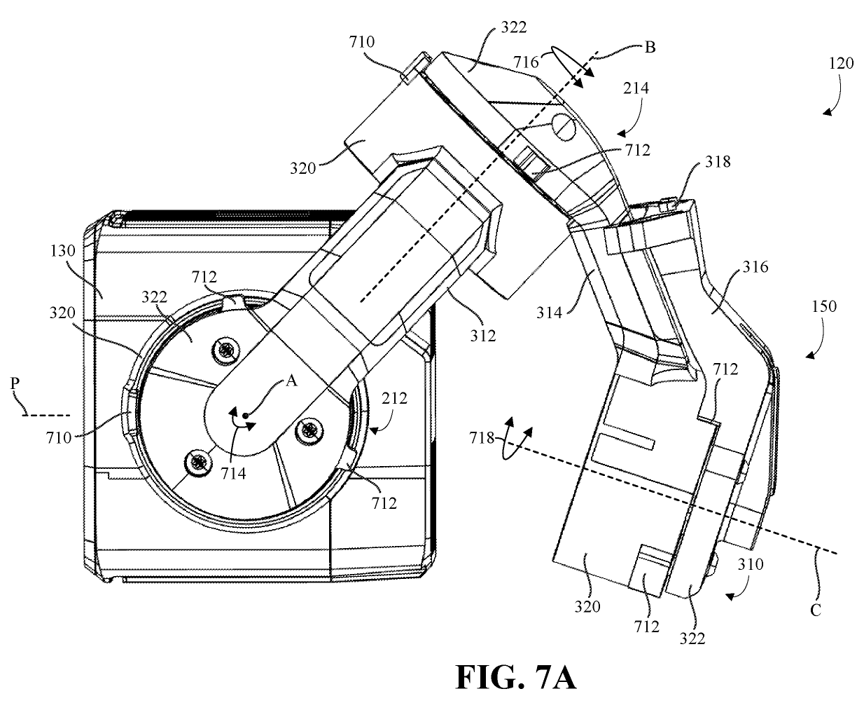

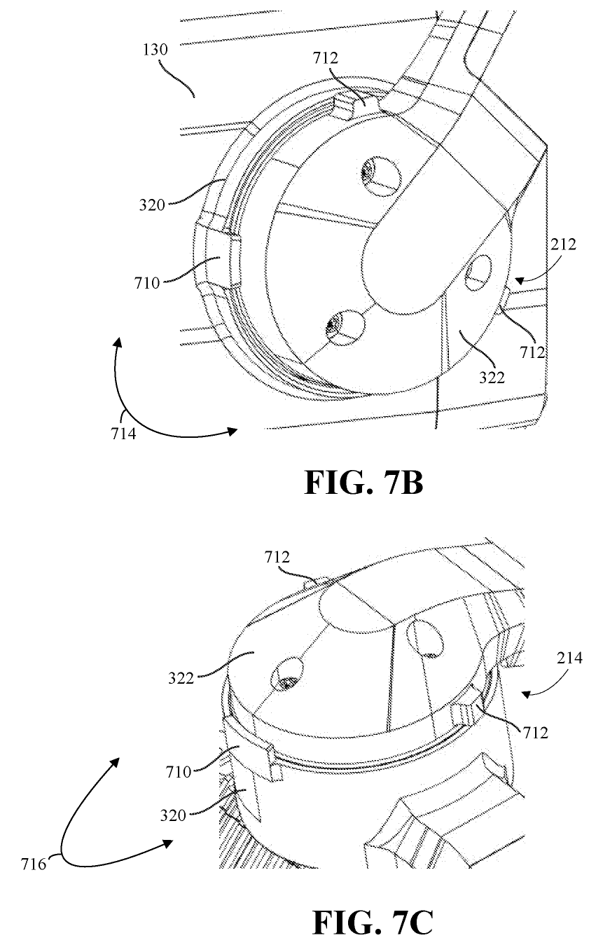

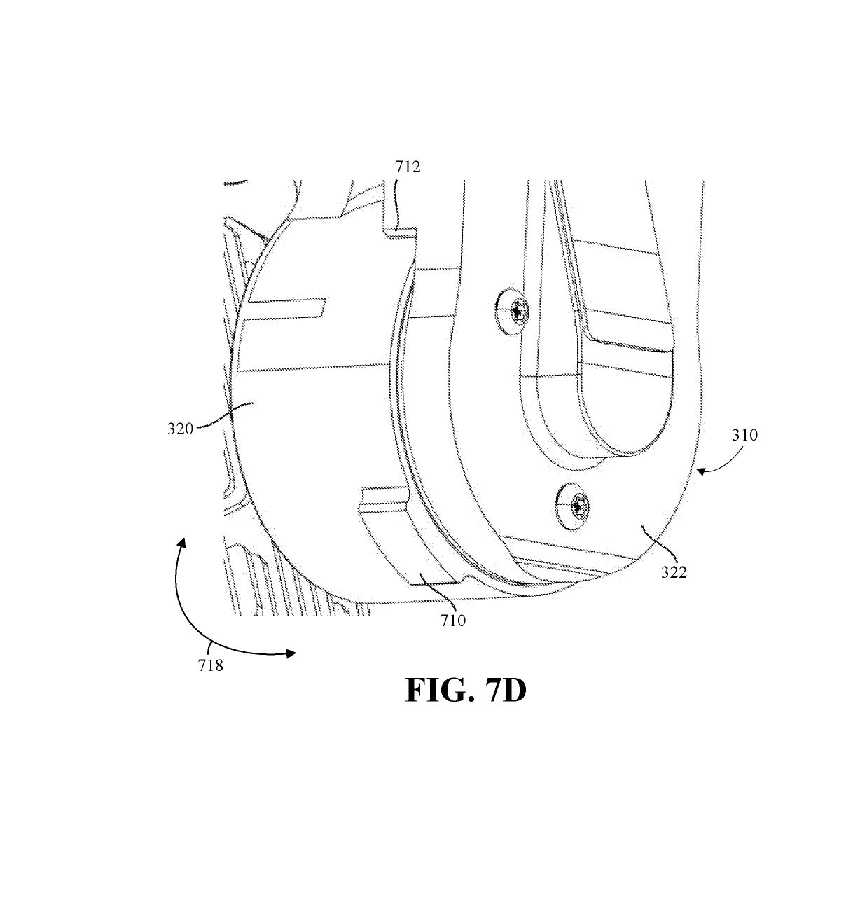

FIG. 7A is a side view of the gimbal system 120 illustrating articulation of the gimbal 150. The frame 140 of the gimbal system 120 has been removed for illustrative purposes. However, it should be noted that in certain embodiments, the gimbal system 120 may be connected to the UAV 100 without the frame 140.

As discussed above, the gimbal 150 may include the motors 212, 214, 310 that are configured to articulate the arms 312, 314, 316 of the gimbal 150. The computing device 412 may be configured to control operation of the motors 212, 214, 310 to articulate the arms 312, 314, 316. The computing device 412 may be further configured to control operation of the image capture device 130. For example, the gimbal 150 may be configured to articulate the image capture device 130 and the computing device 412 may be configured to control image and/or video capture by the image capture device 130. As discussed above, the computing device 412 may be configured to control operation of the image capture device 130, the gimbal 150, or both based upon input (e.g., commands, data, etc.) received by the computing device 412 from the UAV 100 or a system thereof. Similarly, the computing device 412 may also receive input from an external device, such as a user interface, either directly or indirectly (e.g., through the UAV 100).

As discussed above, the gimbal 150 may be coupled to the image capture device 130 and may be configured to articulate the image capture device 130. Each of the motors 212, 214, 310 may include a rotor 320 movably coupled to a stator 322 to articulate all or a portion of the arms 312, 314, 316, the image capture device 130, or both. As described further below, the first motor 212 may be configured to articulate (e.g., rotate) the image capture device 130 about a first axis of rotation (A), the second motor 214 may be configured to articulate (e.g., rotate) the first arm 312 about a second axis of rotation (B), and the third motor 216 may be configured to articulate (e.g., rotate) the second arm 314 about a third axis of rotation (C).

As shown in FIG. 7A, the first motor 212 may be configured to articulate the image capture device 130 in a direction 714 about the first axis rotation (A). It should be noted that the first axis of rotation (A) may extend into the page as shown in FIG. 7A. The image capture device 130 may be coupled to the first motor 212 so that the image capture device 130 rotates about the first axis of rotation (A) of the first motor 212 such that the image capture device 130 may pivot with respect to the first arm 312.

While a range or angle of rotation is not limited by the teachings herein, the rotor 320 of the first motor 212 may include a projection 710 that may be configured to move between end stops 712 of the stator 322. The end stops 712 may be positioned on the stator 322 of the first motor 212 to dictate a range of motion for rotating the image capture device 130. For example, the image capture device 130 may rotate such that the image sensors 210 of the image capture device 130 may tilt with respect to a neutral plane (P) to change a field of view of one or more of the image sensors 210. The neutral plane (P) may be a plane that extends substantially perpendicular to a face of the image capture device 130 that contains the image sensors 210. For example, the neutral plane (P) may extend substantially parallel to the ground and indicate a starting position of the image capture device 130 before movement of the image capture device 130 caused by the gimbal 150. That is, the neutral plane (P) may bisect the image capture device 130 when the image capture device 130 is in the starting position. Additionally, it should be noted that the end stops 712 and/or the projection 710 may be located in different locations based on the configuration desired for the gimbal system 120, thereby providing further customization of the gimbal system 120 depending on the UAV 100 being used.

The second motor 214 may also include a rotor 320 and stator 322 configuration similar to the first motor 212. The second motor 214 may be configured to rotate the first arm 312 about the second axis of rotation (B) in a direction 716. The first arm 312 may rotate about the second axis of rotation (B) to pivot the first arm 312 about the second axis of rotation (B). That is, the first arm 312 may extend along (e.g., is coaxial with) the second axis of rotation (B) so that the first arm 312 may be rotated about the second axis of rotation (B). Alternatively, the first arm 312 may extend or otherwise be offset from the second axis of rotation (B) (e.g., the first arm 312 may be parallel to or non-parallel to second axis of rotation (B)) such that a radius of rotation of the first arm 312 about the second axis of rotation (B) may be greater than when the first arm 312 (e.g., a longitudinal axis thereof) is coaxial with the second axis of rotation (B). For example, the rotor 320 of the second motor 214 may be coaxial with the second axis of rotation (B) and the first arm 312 may extend from the rotor 320 of the second motor 214 such that a radius of rotation of the first arm 312 is greater than a radius of rotation of the rotor 320 of the second motor 214. Additionally, it should be noted that the second motor 214 may also include a projection 710 coupled to the rotor 320 and end stops 712 coupled to the stator 322 to determine a range of motion (e.g., rotation) of the second motor 214, and thus also determine a range of motion of the first arm 312.

As shown in FIG. 7A, the first axis of rotation (A) defined by the first motor 212 may extend substantially orthogonal to the second axis of rotation (B) defined by the second motor 214. While the first axis of rotation (A) may be orthogonal to the second axis of rotation (B), and angle formed therebetween may be possible. For example, in certain configurations, the first axis of rotation (A) may be substantially parallel to the second axis of rotation (B).

The third motor 310 may include a rotor 320 and a stator 322 that are configured to rotate the second arm 314 about the third axis of rotation (C) of the third motor 310 in a direction 718. The second arm 314 may rotate about the third axis of rotation (C) to pivot the second arm 314 about the third axis or rotation (C). That is, the second arm 314 may extend along (e.g., is coaxial with) the third axis or rotation (C) so that the second arm 314 may be rotated about the third axis of rotation (C). Alternatively, the second arm 314 may extend or otherwise be offset from the third axis of rotation (C) (e.g., the second arm 314 may be parallel to or non-parallel to the third axis of rotation (C)) such that a radius of rotation of the second arm 314 about the third axis of rotation (C) may be greater than when the second arm 314 (e.g., a longitudinal axis thereof) is coaxial with the third axis of rotation (C). For example, the rotor 320 of the third motor 310 may be coaxial with the third axis of rotation (C) and the second arm 314 may extend from the rotor 320 of the third motor 310 such that a radius of rotation of the second arm 314 is greater than a radius of rotation of the rotor 320 of the third motor 310. Additionally, it should be noted that the third motor 310 may also include a projection 710 coupled to the rotor 320 and end stops 712 coupled to the stator 322 to determine a range of motion (e.g., rotation) of the third motor 310, and thus also determine a range of motion of the second arm 314.

As shown in FIG. 7A, the third axis of rotation (C) defined by the third motor 310 may extend orthogonal to both the first axis of rotation (A) and the second axis of rotation (B) to permit rotation of the gimbal 150 in multiple directions. However, any angle may be formed between the third axis of rotation (C) and the first axis of rotation (A) and/or between the third axis of rotation (C) and the second axis of rotation (B). Therefore, based on the positioning of each of the axes of rotation (A, B, C), rotation about any one of the axes of rotation (A, B, C) may result in movement of the image capture device 130. That is, based upon operation of the gimbal 150, the image capture device 130 may translate in one or more directions (e.g., along the neutral plane (P) and/or orthogonally to the neutral plane (P)) and/or may rotate in one or more directions (e.g., pivot about the first axis of rotation (A), rotate about the second axis of rotation (B), or rotate about the third axis of rotation (C)).

In a similar manner, the gimbal 150 may be operated to maintain an orientation and/or position of the image capture device 130 (e.g., a starting position with respect to the neutral plane (P)) during operation of the UAV 100. That is, during flight of the UAV 100, the UAV 100 may pitch, tilt, translate, or otherwise move, which may result in movement of the field of view of the image sensors 210 disposed in the image capture device 130. To maintain an orientation of the image capture device 130 and thus the field of view of the image sensors 210, the gimbal 150 may operate (e.g., rotate the image capture device 130 in the direction 714, rotate the first arm 312 in the direction 716, and/or rotate the second arm 314 in the direction 718) to counteract movement of the UAV 100.

To further illustrate the above articulation, the image capture device 130 may be configured to rotate in three degrees of freedom as defined by the first axis of rotation (A), the second axis of rotation (B), and the third axis of rotation (C). That is, the image capture device 130 may pivot about the first axis of rotation (A), the second axis of rotation (B), and the third axis of rotation (C). Due to the first axis of rotation (A), the second axis of rotation (B), and the third axis of rotation (C) being orthogonal to one another, the image capture device 130 may pivot with respect to any one of the axes of rotation (A, B, C) without translating the image capture device 130 with respect to the gimbal 150.

As shown in FIG. 7A, the third arm 316 may include the attachment portion 318 and may be configured to connect the gimbal 150 to the frame 140 of the gimbal system 120 or even directly to the UAV 100. In such a configuration, the third arm 316 may remain stationary during operation of the gimbal 150 and/or the image capture device 130. In other embodiments, the third arm 316 may also be configured to articulate to provide a further range of motion if desired, such as by incorporating a fourth motor into the gimbal 150.

FIG. 7B is a close-up view of the first motor 212 shown in FIG. 7A. As discussed above, the first motor 212 may be movably coupled to the image capture device 130 and configured to articulate the image capture device 130 in the direction 714 about the first axis of rotation (A). The first motor 212 may include the rotor 320. The rotor 320 may be coupled to the image capture device 130 or otherwise formed with the image capture device. The rotor 320 may be configured to rotate with respect to the stator 322 of the first motor 212 in the direction 714. The range of motion in the direction 714 may be determined by a travel path between the end stops 712 of the stator 322. That is, the projection 710 of the rotor 320 may be configured to travel along the travel path in the direction 714 between the end stops 712 until the projection 710 contacts one of the end stops 712, thereby preventing overtravel of the first motor 212. As such, the end stops 712 may further tune a desired articulation range of the first motor 212.

The projection 710 may be coupled to, or formed with, the rotor 320 of the first motor 212. The projection 710 may be formed with the image capture device 130. The projection 710 may extend or project at any desired angle or in any desired direction to facilitate engagement (e.g., contact) between the projection 710 and the end stops 712. Similarly, the projection 710 may be any desired size and/or shape.

The end stops 712 may be coupled to, or formed with, the stator 322 of the first motor 212. For example, the end stops 712 may extend radially away from the first axis of rotation (A) substantially orthogonal to the first axis of rotation (A). The end stops 712 may be movably coupled to the first motor 212 or a portion of the gimbal system 120 to facilitate adjustability of the end stops 712, thereby facilitating adjustability of the range of motion of the first motor 212. The end stops 712 may extend or project at any desired angle or in any desired direction to facilitate engagement (e.g., contact) between the projection 710 and the end stops 712. Similarly, the end stops 712 may be any desired size and/or shape. Additionally, it should be noted that while the projection 710 and the end stops 712 are illustrated as being coupled to the rotor 320 and the stator 322, respectively, the projection 710 and the end stops 712 may be coupled to any portion of the gimbal system 120 to provide a similar configuration.

FIG. 7C is a close-up view of the second motor 214 shown in FIG. 7A. As discussed above, the second motor 214 may be movably coupled to the first arm 312 and configured to articulate the first arm 312 in the direction 716 about the second axis of rotation (B). The second motor 214 may include the rotor 320 and the stator 322 as shown. The rotor 320 of the second motor 214 may be configured to rotate with respect to the stator 322 of the second motor 214 in the direction 716. The range of motion in the direction 716 may be determined by a travel path between the end stops 712 of the stator 322. That is, the projection 710 of the rotor 320 may be configured to travel along the travel path in the direction 714 between the end stops 712 until the projection 710 contacts one of the end stops 712, thereby preventing overtravel of the first motor 212

The projection 710 may be coupled to, or formed with, the rotor 320 of the second motor 214. The projection 710 may be formed with the first arm 312. The projection 710 may extend or project at any desired angle or in any desired direction facilitate engagement (e.g., contact) between the projection 710 and the end stops 712. The projection 710 of the second motor 214 may be similar to, or the same as, the projection 710 of the first motor 212.

The end stops 712 may be coupled to, or formed with, the stator 322 of the second motor 214. For example, the end stops 712 may extend radially away from the second axis of rotation (B) substantially orthogonal to the second axis of rotation (B). The end stops 712 may be movably coupled to the second motor 214 or a portion of the gimbal system 120 to facilitate adjustability of the end stops, thereby facilitating adjustability of the range of motion of the second motor 214. The end stops 712 may extend or project at any desired angle or in any desired direction to facilitate engagement (e.g., contact) between the projection 710 and the end stops 712. Similarly, the end stops 712 may be any desired size and/or shape. Additionally, it should be noted that while the projection 710 and the end stops 712 are illustrated as being coupled to the rotor 320 and the stator 322, respectively, the projection 710 and the end stops 712 may be coupled to any portion of the gimbal system 120 to provide a similar configuration. Additionally, the end stops 712 may be similar to, or the same as, the end stops 712 of the first motor 212.

FIG. 7D is a close-up view of the third motor 310 shown in FIG. 7A. As discussed above, the third motor 310 may be movably coupled to the second arm 314 and the third arm 316 of the gimbal 150. The third motor 310 may be configured to articulate the second arm 314 in the direction 718 about the third axis of rotation (C). The third motor 310 may include the rotor 320 and the stator 322 as shown. The rotor 320 of the second motor 214 may be configured to rotate with respect to the stator 322 of the third motor 310 in the direction 718. The range of motion in the direction 718 may be determined by a travel path between the end stops 712 of the stator 322. That is, the projection 710 of the rotor 320 may be configured to travel along the travel path in the direction 718 between the end stops 712 until the projection 710 contacts one of the end stops 712, thereby preventing overtravel of the third motor 310.

The projection 710 may be coupled to, or formed with, the rotor 320 of the third motor 310. The projection 710 may be formed with the second arm 314 and/or the third arm 316. The projection 710 may extend or project at any desired angle or in any desired direction facilitate engagement (e.g., contact) between the projection 710 and the end stops 712. The projection 710 of the third motor 310 may be similar to, or the same as, the projection 710 of the first motor 212 and/or the second motor 214.

The end stops 712 may be coupled to, or formed with, the stator 322 of the third motor 310. For example, the end stops 712 may extend radially away from the third axis of rotation (C) substantially orthogonal to the third axis of rotation (C). The end stops 712 may be movably coupled to the third motor 310 or a portion of the gimbal system 120 to facilitate adjustability of the end stops, thereby facilitating adjustability of the range of motion of the third motor 310. As shown in FIG. 7D, the end stops 712 may be formed with the third arm 316 and/or the stator 322 of the third motor 310. For example, the end stops 712 may be a projection or notch located along the third arm 316 that is configured to contact the projection 710 of the third motor 310.

The end stops 712 may extend or project at any desired angle or in any desired direction to facilitate engagement (e.g., contact) between the projection 710 and the end stops 712. Similarly, the end stops 712 may be any desired size and/or shape. Additionally, it should be noted that while the projection 710 and the end stops 712 are illustrated as being coupled to the rotor 320 and the stator 322, respectively, the projection 710 and the end stops 712 may be coupled to any portion of the gimbal system 120 to provide a similar configuration. Additionally, the end stops 712 may be similar to, or the same as, the end stops 712 of the first motor 212 and/or the second motor 214.

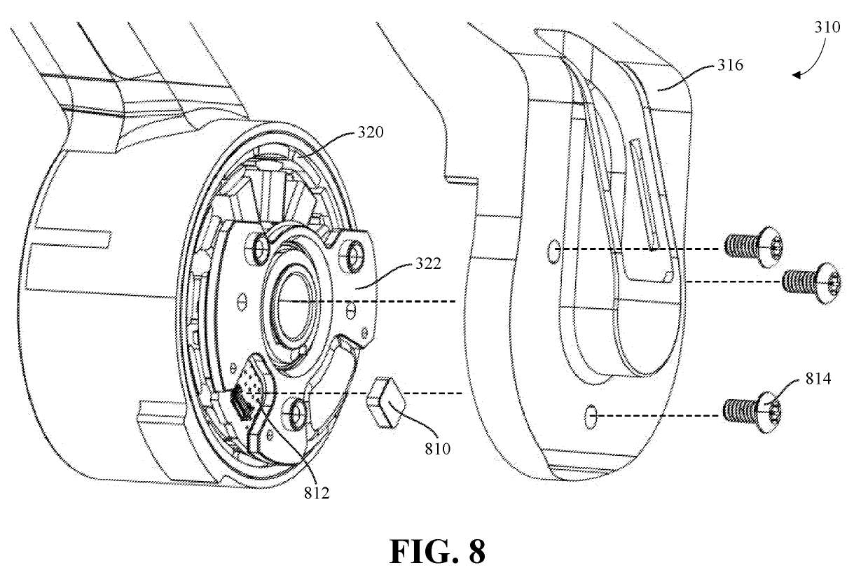

FIG. 8 illustrates an exploded view of the third motor 310. It should be noted that the exploded view of the third motor 310 may illustrate a similar configuration as the first motor 212 and second motor 214. That is, FIG. 8 as described below may also be applicable to the first motor 212 and the second motor 214 unless otherwise stated.

As discussed above, each of the motors 212, 214, 310 may include a rotor 320 and a stator 322. The rotor 320 may be at least partially disposed around the stator 322 and may be configured to rotate with respect to the stator 322. The rotor 320 may be fixed to one of the arms 312, 314, 316 to articulate the arms 312, 314, 316 based on rotation of the rotor 320. For example, as shown in FIG. 8, the rotor 320 of the third motor 310 may be coupled to, or integrated with, the third arm 316 to articulate the third arm 316. However, a similar configuration may be present between the first motor 212 and the image capture device 130, between the second motor 214 and the first arm 312, or both. The arms 312, 314, 316 may each include an interior cavity configured to at least partially house the rotor 320 and the stator 322. For example, as shown in FIG. 8, the third arm 316 may include an interior cavity that may house the stator 322 of third motor 310, whereby the stator 322 may be coupled to the third arm 316 by one or more fasteners 814. The fasteners 814 may extend through an outer planar surface of the third arm 316 and may be received by apertures defined by the rotor 320 of the third motor 310, thereby coupling the third arm 316 to the rotor 320.

The motors 212, 214, 310 may each include one or more position sensors 810. The position sensor(s) 810 may be configured to determine a rotational position of the motors 212, 214, 310. That is, the position sensor(s) 810 may be configured to determine a position of the rotor 320 with respect to the stator 322 of each of the motors 212, 214, 310 based upon rotation of the rotor 320 with respect to the stator about a respective one of the axes of rotation (A, B, C). As a result, the position sensor(s) 810 may actively (e.g., continuously or intermittently) determine the position of the motors 212, 214, 310 during operation of the gimbal system 120.

The position information determined by the position sensor(s) 810 may be provided by the position sensor(s) 810 to the computing device 412 of the gimbal system 120. The position information determined by the position sensor(s) 810 may be provided to the computing device 412 as an operating characteristic of the gimbal system 120 that may be utilized or evaluated for calibration of the gimbal system 120, the UAV 100, or both. That is, the position information determined by the position sensor(s) 810 may be a part of the calibration data of the gimbal system 120 that may be provided to the computing device 412 and/or the UAV 100 to calibrate operation of the gimbal system 120 and/or the UAV 100, such a propulsion mechanism operation of the UAV 100 to determine flight of the UAV 100.

The position information determined by the position sensor(s) 810 may also be provided to a user interface (e.g., an external device) in communication with the gimbal system 120 and/or the UAV 100, such as discussed in further detail below. As a result, the position information from the position sensor(s) 810 may be provided to the UAV 100 and/or the user interface to initialize operation of the gimbal system 120, to control operation of the gimbal system 120 via the user interface, or both. For example, the user interface may generate a command to initialize operation of the gimbal system 120. The initialize operation of the gimbal system 120 may utilize an algorithm and/or evaluation procedure (e.g., using the computing device 412) to determine an initial position of the gimbal system 120 prior to any movement command being initiated through the user interface. Such an algorithm and/or evaluation procedure may utilize the position information from the positions sensor(s) 810 to determine the position of each of the motors 212, 214, 310 and/or the arms 312, 314, 316.

Similarly, commands may be initialized and generated from the user interface to control operation of the gimbal system 120, whereby the commands from the user interface may be executed based on the position information provided by the position sensor(s) 810. For example, a user may initialize and generate a command from the user interface to articulate one or more of the arms 312, 314, 316 by the motors 212, 214, 310. The command may be received by the computing device 412 of the gimbal system 120 and may be analyzed to determine if such a movement command is possible given a current position of the arms 312, 314, 316 based upon the position information from the position sensor(s) 810. That is, articulation of the gimbal system 120 may be predicated on the position information provided by the position sensor(s) 810.

While the position information provided by the position sensor(s) 810 may be provided to the computing device 412 of the gimbal system 120, the UAV 100, a user interface, or a combination thereof for any desired operation, it is envisioned that the position sensor(s) 810 may be particularly beneficial in providing the position information for fine motor accuracy. That is, the position sensor(s) 810 may precisely determine a position of the motors 212, 214, 310 and/or the arms 312, 314, 316 to facilitate accurate and fine movement of the motors 212, 214, 310 and/or the arms 312, 314, 316. Thus, an increment of movement of each of the motors 212, 214, 310 may be substantially less than a conventional gimbal system.

It should also be noted that the position information provided by the position sensor(s) 810 may be used in conjunction with additional position information provided by the gimbal system 120 and/or the UAV 100 to initialize and/or control operation of the gimbal system 120 and the UAV 100, as described above. For example, the position sensor(s) 810 may be used in conjunction with one or more inertial measurement units (IMUs) that may be configured to measure and provide measurement values pertaining to a specific force, angular rate, orientation, or a combination thereof of the gimbal system 120 and/or the UAV 100. The IMU(s) may include one or more accelerometers, gyroscopes, magnetometers, or a combination thereof to measure the specific force, angulate rate, orientation, or a combination thereof of the gimbal system 120 and/or the UAV 100. The position information from the position sensor(s) 810 and the measurement values from the IMU(s) may be provided to the computing device 412 of the gimbal system 120, may be provided to the UAV 100, may be provided to the user interface, or a combination thereof, to initialize and/or operate the gimbal system 120.

As stated above, an algorithm and/or an evaluation procedure may be used to evaluate the data provided by the position sensor(s) 810 and the IMU(s). By way of example, the computing device 412 of the gimbal system 120 and/or a computing device of the UAV 100, may be configured to evaluate the information provided by the position sensor(s) 810 and the IMU(s) using a sensor fusion process. As a result, data from various sensors or measurement devices (e.g., the position sensor(s) 810 and sensors of the IMU(s)) may be combined or otherwise manipulated to determine a position of the gimbal system 120 with less certainty (i.e., more accurately) than a conventional gimbal system. However, it should be noted that any algorithm and/or evaluation procedure may be utilized.

The position sensor(s) 810 may be any type of position sensor. The position sensor(s) 810 may be a potentiometer, an inductive sensor, a capacitive sensor, an ultrasonic transducer, or a combination thereof. As shown in FIG. 8, the position sensor(s) 810 may be a Hall effect sensor that is configured to detect the Hall effect within each of the motors 212, 214, 310 and convert such detection into data that may be provided to the computing device 412, the UAV 100, the user interface, or a combination thereof. The position sensor(s) 810 may be positioned within a groove 812 or receiving portion along the stator 322 to couple the position sensor(s) 810 to the stator 322. The groove 812 may be a cutout, receiving portion, notch, channel, cutout, or a combination thereof that may be configured to receive at least a portion of the position sensor(s) 810. As a result, the position sensor(s) 810 may be coupled to the stator 822 adjacent to the rotor 320 so that the stator 322 may determine a position of the rotor 320 with respect to the stator 322 (e.g., by measuring a state of the magnetic field based upon the rotation of the rotor 320). However, it is envisioned that the position sensor(s) 810 may be positioned anywhere with respect to the motors 212, 214, 310 to accurately determine the position of the motors 212, 214, 310 (e.g., a position of the rotor 320 with respect to the stator 322 of each of the motors 212, 214, 310).

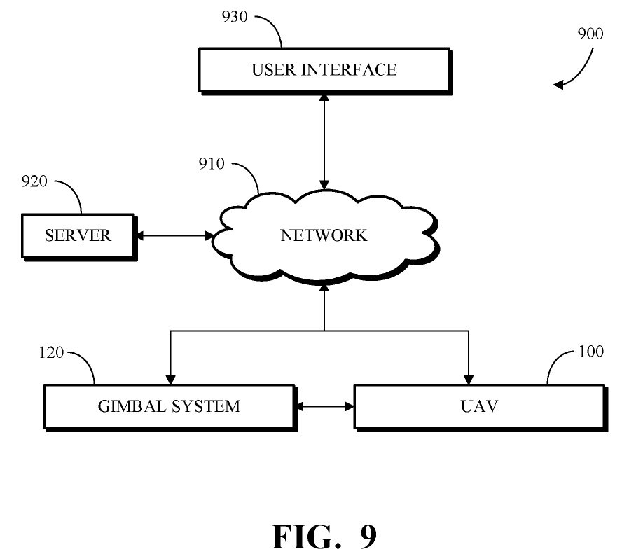

FIG. 9 is a flowchart 900 of a network configuration for the UAV 100 and the gimbal system 120 removably coupled to the UAV 100. In certain embodiments, it is envisioned that more than two UAVs similar or different than the UAV 100 may be present. As such, the network configuration shown in FIG. 9 may also apply to configurations with any number of the UAV 100.

The UAV 100 may be in communication with the gimbal system 120. As discussed above, the UAV 100 and the gimbal system 120 may be in contact with one another mechanically and/or electrically (e.g., through the connector 610 of the computing device 412 of the gimbal system 120) when the gimbal system 120 is removably coupled to the UAV 100. The gimbal system 120 and the UAV 100 may also establish wireless connection between one another, such that the gimbal system 120 may wirelessly transfer data to the UAV 100, or vice versa.

The UAV 100 and/or the gimbal system 120 may be controlled autonomously by one or more onboard processing aspects (e.g., the computing device 412 of the gimbal system 120) or remotely controlled by an operator. For example, an operator (e.g., a user) may control operation or otherwise communicate with the UAV 100 and/or the gimbal system 120 via a user interface 930. The user interface 930 may be an electronic device in which the user may interface with the UAV 100 and/or the gimbal system 120 before, during, or after flight of the UAV 100. The electronic device may be an electronic device that is remotely located from the UAV 100 and the gimbal system 120, such as, for example, a mobile phone, tablet, laptop, desktop, wireless controller, or a combination thereof. The user interface 930 may be similar to the user interface discussed above with respect to FIG. 8.

The UAV 100 and the gimbal system 120 may be in wireless communication (e.g., wireless connection) with the user interface 930 via a network 910 connection. The user interface 930 may communicate with the UAV 100 and the gimbal system 120 via the network 910 using a wireless communications link (e.g., a Wi-Fi network, a Bluetooth link, a ZigBee link, or another network or link). Additionally, it is envisioned that the user interface 930 may communicate with the UAV 100 and the gimbal system 120 via a cloud-based network 910 in which the user interface 930 is located remotely from the UAV 100 and the gimbal system 120. In other words, the user interface 930 may be located off-site from a location of the UAV 100 yet still wirelessly communicate with the UAV 100 and the gimbal system 120 via the cloud-based network 910. To support the cloud-based connection between the user interface 930 and the UAV 100 coupled to the gimbal system 120, the user interface 930, the UAV 100, the gimbal system 120, or a combination thereof may also be in communication with a server 920. The server 920 may be remotely located and configured to store data for the user interface 930, the UAV 100, the gimbal system 120, or a combination thereof. The server 920 may communicate with the user interface 930, the UAV 100, the gimbal system 120, or a combination thereof via the cloud-based network 910. As a result, the user interface 930, the UAV 100, the gimbal system 120, or a combination thereof may access data stored on the server 920.

By way of example, the remote device as discussed above may access the server 920 to establish the user interface 930. The user interface 930 may receive data from the server 920 to establish one or more possible commands for the user. The executed commands from the user via the user interface 930 may correlate to one or more actions of the gimbal system 120 and/or the UAV 100 (e.g., establish a designated flight path, establish a scan mode and/or scan schedule of the UAV 100 using the gimbal system 120, execute autonomous flight of the UAV 100, execute a software update of the UAV 100, execute autonomous operation of the gimbal system 120, initialize operation of the gimbal system 120, calibrate the gimbal system 120 and/or the UAV 100, etc.).

Similarly, the UAV 100 and/or the gimbal system 120 may access the server 920 to transfer data to the server 920 for access via the user interface 930. For example, the UAV 100 may transfer flight data, operation data, error/fault data, or other data to the server 920. Similarly, the gimbal system 120 may transfer images and/or video captured by the image capture device 130 to the server 920. As a result, the user may then access the data stored on the server 920 via the user interface 930.

As may be gleaned from the above examples, the cloud-based network 910 may facilitate entirely remote communication between a user and the UAV 100, the gimbal system 120, or both (e.g., via the user interface 930). Therefore, the gimbal system 120 and the UAV 100 may only require an initial installation in-person and may thereafter be accessible offsite by the user.

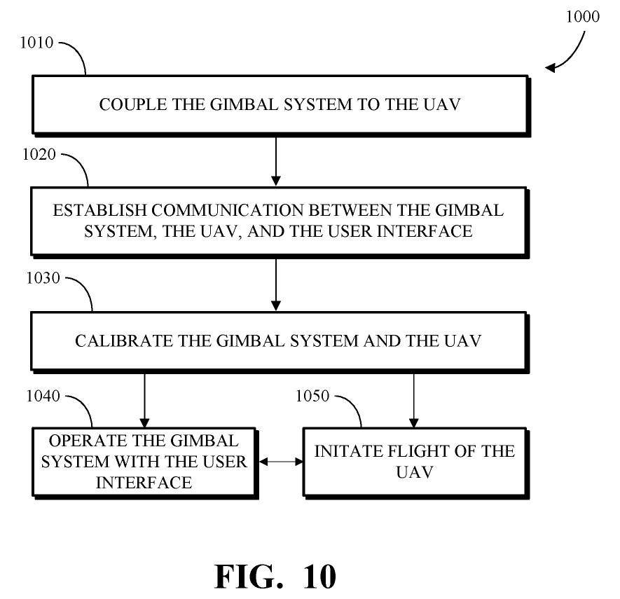

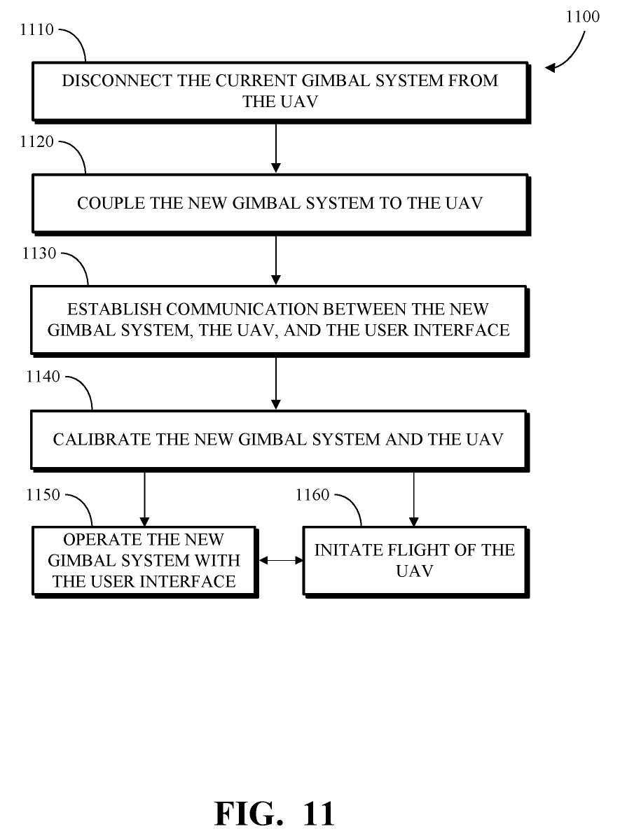

FIG. 10 illustrates a flowchart 1000 of an example process for installing and operating the gimbal system 120 of the UAV 100. The process may be applicable to one or more UAVs 100. In other words, the process shown in the flowchart 900 may be completed for a plurality of UAVs 100.

Initially, a user may mount the gimbal system 120 to the UAV 100 at an operation 1010. As discussed above, the gimbal system 120 may be removably coupled to the UAV 100 and may be configured to movably couple a device of the gimbal system 120, such as the image capture device 130 discussed above, to the UAV 100. Once the gimbal system 120 is coupled to the UAV 100 at the operation 1010, communication may be established between the gimbal system 120, the UAV 100, and the user interface 930 at operation 1020. As discussed above, the gimbal system 120 may be electrically and removably coupled to the UAV 100 so that the computing device 412 is in communication with the UAV 100. For example, the connector 610 of the gimbal system 120 may be connected to a connector of the UAV 100, thereby establishing a wired connection between the gimbal system 120 and the UAV 100. Additionally, as discussed above with respect to the flowchart 900, the user interface 930 may establish wireless communication with the gimbal system 120 and/or the UAV 100 through the network 910.

Once communication is established at the operation 1020, the gimbal system 120 and/or the UAV 100 may be calibrated at operation 1030. As discussed herein, the gimbal system 120 may provide calibration data to the UAV 100 based upon calibration data stored on the computing device 412 of the gimbal system 120. The calibration data may be pre-defined parameters based upon one or more characteristics of the gimbal system 120. For example, the one or more characteristics of the gimbal system 120 may include at least one of: a weight of the gimbal system 120, a center of mass of the gimbal system 120, moments of inertia of one or more axes of rotation of the gimbal system 120 (e.g., axes of rotation of the motors 212, 214, 310), operation characteristics of the gimbal 150 (e.g., movement and/or positioning of the motors 212, 214, 310), and operation characteristics of the image capture device 130. Such characteristics of the gimbal system 120 may be based upon fixed parameters of the gimbal system 120 (e.g., a weight of the gimbal system 120). However, one or more of the characteristics of the gimbal system 120 may be dynamically (e.g., continuously) updated based upon operation and/or a status of the gimbal system 120, such as a position of the gimbal 150, a position of the image capture device 130, a fault of the gimbal 150 and/or the image capture device 130, etc. Such characteristics of the gimbal system 120 may be updated based upon measurements (e.g., data) provided by sensors or other devices of the gimbal system 120 or the UAV 100 (e.g., the position sensor(s) 810). Based on the aforementioned data stored and/or collected by the gimbal system 120, the UAV 100, or both, the gimbal system 120 and the UAV 100 may be calibrated.

Calibration of the gimbal system 120 may establish an initial position of the gimbal system 120, an initial status of the gimbal system 120 (e.g., detection of faults, errors, service requirements, etc.), or other parameters of the gimbal system 120 that may be relevant to operate the gimbal system via the user interface 930. Similarly, calibration of the UAV 100 may utilize the calibration data to modify propulsion characteristics or other flight characteristics of the UAV 100. For example, operation of the propulsion mechanism(s) 110 of the UAV 100 may be modified based upon the calibration data provided to the UAV 100. As a result, flight of the UAV 100 may accommodate for the added size and/or weight of the gimbal system 120 coupled to the UAV 100.

Calibration of the UAV 100 may be based upon the calibration data provided to the UAV 100 by the gimbal system 120 (or the computing device 412 therein) and/or additional calibration data stored on the UAV 100 or provided to the UAV 100. The additional calibration data may be stored on a computing device of the UAV 100, may be provided to the UAV 100 through the network 910 from the server 920 and/or the user interface 930, or a combination thereof. As a result, the UAV 100 may be dynamically calibrated based upon characteristics of the UAV 100 and/or characteristics of the gimbal system 120 coupled to the UAV 100.

Once calibration of the gimbal system 120 and/or the UAV 100 is completed at the operation 1030, a user may operate the gimbal system 120 with the user interface 930 at operation 1040. The gimbal system 120 may be operated by a user through the user interface 930, whereby the user interface 930 may be configured to generate and provide commands to the computing device 412 of the gimbal system 120 to operate the gimbal system 120. For example, through the user interface 930, the gimbal 150 of the gimbal system 120 may be articulated to move the image capture device 130, the image capture device 130 may be controlled to capture images and/or videos, or both. Additionally, as discussed in further detail below, the gimbal system 120 may be configured through the user interface 930 to autonomously operate in a scan mode, whereby a scan schedule, flight path, and other parameters are established using the user interface 930.

Additionally, once calibration of the gimbal system 120 and/or the UAV 100 is completed at the operation 1030, flight of the UAV 100 may be initiated at operation 1050. Flight of the UAV 100 may be fully or substantially autonomous based upon initial commands generated and provided through the user interface 930 or the UAV 100 may be manually controlled using the user interface 930. Additionally, it should be noted that flight of the UAV 100 at the operation 1050 may be done simultaneously with operation of the gimbal system 120 at the operation 1040. Flight of the UAV 100 at the operation 1050 may also be done independently of operation of the gimbal system 120 at the operation 1040, or vice versa.

FIG. 11 illustrates a flowchart 1100 of an example of a process for interchanging gimbal systems of the UAV 100. As discussed above, the gimbal system 120 may be interchangeable with one or more additional gimbal systems or other attachments of the UAV 100. The additional gimbal system(s) or other attachments of the UAV 100 may be similar to the gimbal system 120 or may include one or more different features.

At operation 1110, the gimbal system 120 may be disconnected from the UAV 100. As discussed above, the gimbal system 120 may be removably coupled to the UAV 100 and may facilitate easy connection and disconnect with respect to the UAV 100. Once the gimbal system 120 is disconnected at the operation 1110, a new gimbal system may be coupled to the UAV 100 at operation 1120. The new gimbal system may be the same as, or different from, the gimbal system 120 discussed herein. For example, the gimbal system 120 may be damaged or otherwise require repair and/or replacement. As a result, a new gimbal system may be coupled to the UAV 100, whereby the new gimbal system may be a replacement with a similar or the same configuration as the gimbal system 120. Alternatively, the new gimbal system may provide a different configuration, whereby the new gimbal system may operate in different conditions and/or may provide additional or alternative functionality (e.g., night vision, infrared, etc.).

Once the new gimbal system is coupled to the UAV 100 at the operation 1120, communication may be established between the new gimbal system, the UAV 100, and the user interface 930 at operation 1130. The operation 1130 may be similar to the operation 1020 of the flowchart 1000 to establish communication.

Once communication is established at the operation 1130, the new gimbal system and/or the UAV 100 may be calibrated at operation 1140. Calibration at the operation 1140 may be completed similar to the operation 1030 for calibrating the gimbal system 120 and the UAV 100. As discussed above, the gimbal system 120 and the new gimbal system coupled to the UAV 100 in the operation 1120 may be configured to provide calibration data to the UAV 100 to calibrate flight characteristics of the UAV 100. Beneficially, due to the modular configuration the gimbal system 120 and the new gimbal system based on the teachings herein, the gimbal system 120 and the new gimbal system may be configured to be interchanged due to calibration data being stored on the computing device 412 of the gimbal system 120 or a similar structure of the new gimbal system. As a result, the gimbal system 120 and the new gimbal system may have the same or different calibration data based upon the characteristics particular to each of the gimbal systems. Thus, if different calibration data exists between the gimbal system 120 and the new gimbal system, such calibration data that is different for both gimbal systems may not need to be stored on the UAV 100, yet calibration may still be done quick and may be tailored to the gimbal system coupled to the UAV 100.

After calibration is completed at the operation 1140, operation of the new gimbal system with the user interface 930 may be done at operation 1150. Similarly, flight of the UAV 100 may be initiated at operation 1160 with the user interface 930. Operation 1150 may be similar to the operation 1040 in the flowchart 1000. Operation 1160 may be similar to the operation 1050 in the flowchart 900. Additionally, operation of the new gimbal system and flight of the UAV 100 may be done at the same time or independent of one another.

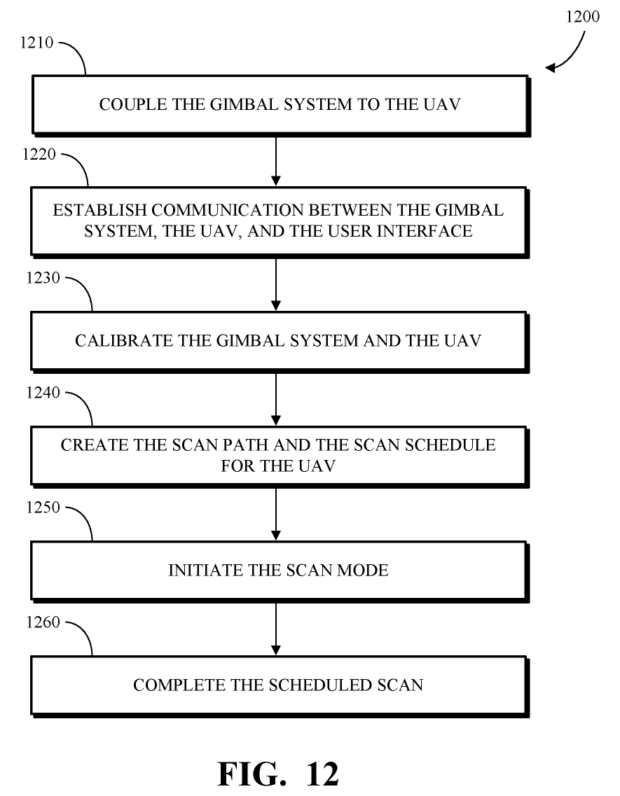

FIG. 12 illustrates a flowchart 1200 of an example of a process for initiating an autonomous scan mode of the UAV 100. Initially at operation 1210, the gimbal system 120 may be removably coupled to the UAV 100 as discussed above. Communication between the gimbal system 120, the UAV 100, and the user interface 930 may then be established at operation 1220. Communication may be established similar to the operations 1020, 1130 discussed above. Once communication is established at the operation 1220, the gimbal system 120 and/or the UAV 100 may be calibrated at operation 1230. Calibration at the operation 1230 may be similar to the calibration completed at the operations 1030, 1140 discussed above.

Once calibration at the operation 1230 is completed, a scan path and a scan schedule for the UAV 100 may be created at the operation 1240. The scan path and the scan schedule may be created using the user interface 930 and provided to the UAV 100. The scan path may establish a pre-defined flight path of the UAV 100 in a designated area, building, etc. Similarly, the scan schedule may establish a flight schedule of the UAV 100 along the scan path. Based on the created scan path and scan schedule, the UAV 100 may autonomously fly the scan path at the designated times based on the scan schedule.

The scan path and the scan schedule created at the operation 1240 may also include parameters for operation of the gimbal system 120. That is, the gimbal system 120 may be configured for operation to complete the scan along the scan path based upon the scan schedule created. The image capture device 130 may be configured to capture images and/or video along the scan path. For example, the image capture device 130 may provide a live video feed along the scan path. The image capture device 130 may be configured to be controlled by a user through the user interface 930 to manually conduct the scan along the scan path. However, it is envisioned that the gimbal system 120 may be configured to be autonomously operated along the scan path. For example, the gimbal system 120 may include one or more sensors that may be configured to track an object or item (e.g., a bridge, a ship, a building, etc.), whereby the image capture device 130 is configured to capture images and/or video of the object or item along the scan path.

Once the scan path and the scan schedule are created in the operation 1240, the scan mode of the UAV 100 may be initiated at operation 1250. Scan mode may be initiated to begin autonomous operation of the UAV 100 and/or the gimbal system 120 along the created scan path based upon the created scan schedule. The scan mode of the UAV 100 may be initiated through the user interface 930.

After the scan mode has been initiated at the operation 1250, the UAV 100 may complete the scheduled scan at operation 1260 based upon the scan path and the scan schedule. Results from the scan, such as images and/or video captured by the image capture device 130, may be transmitted to the user interface 930, the server 920, or both for access and review by a user. However, any data collected during the scan mode may be transmitted and/or manipulated in any desired manner.

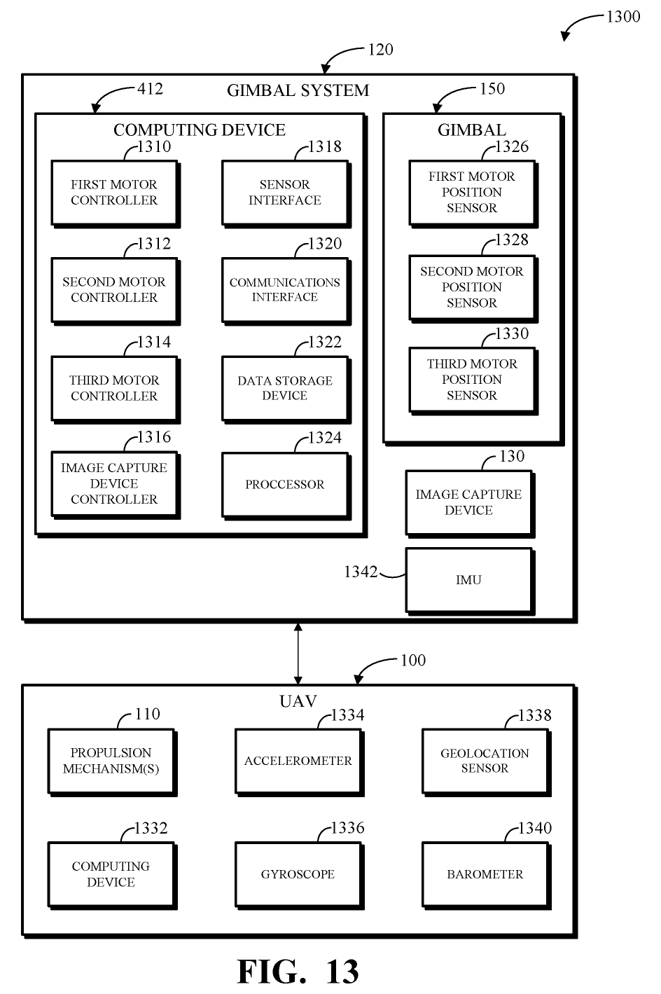

FIG. 13 illustrates a block diagram of an example of a hardware configuration of the gimbal system 120 removably coupled to the UAV 100. The hardware configuration of the gimbal system 120 may be connected or in communication with UAV 100 and a hardware configuration thereof. The gimbal system 120 may include the computing device 412, the image capture device 130, and the gimbal 150 as described above. The computing device 412 of the gimbal system 120 may include a first motor controller 1310, a second motor controller 1312, a third motor controller 1314, an image capture device controller 1316, a sensor interface 1318, a communication interface 1320, a data storage device 1322, and a processor 1324.

The computing device 412 may be operable to execute instructions that have been stored in the data storage device 1322 or elsewhere. The computing device 412 may be a processor with random access memory (RAM) for temporarily storing instructions read from the data storage device 1322 or elsewhere while the instructions are being executed. The computing device 412 may include a single processor (e.g., the processor 1324) or multiple processors each having single or multiple processing cores. Alternatively, the computing device 412 may include another type of device, or multiple devices, capable of manipulating or processing data (e.g., a processing apparatus). For example, all or some of the above operations of the computing device 412 may be done by the processor 1324 or one or more additional processors of the computing device 412. The computing device 412 may be arranged into a processing unit, such as a central processing unit (CPU) or a graphics process unit (GPU).

The data storage device 1322 may be a non-volatile information storage device, for example, a solid-state drive, a read-only memory device (ROM), an optical disc, a magnetic disc, or another suitable type of storage device such as a non-transitory computer readable memory. The data storage device 1322 may include another type of device, or multiple devices, capable of storing data for retrieval or processing by the computing device 412 or the processor 1324 thereof. The computing device 412 may access and manipulate data stored in the data storage device 1322 (e.g., through an interconnect of the computing device 412, such as a bus or a wired or wireless network (e.g., a vehicle area network).

The sensor interface 1318 may be configured to control and/or receive data from one or more sensors of the gimbal system 120. For example, the sensor interface 1318 may be configured to control and/or receive data from a first motor position sensor 1326 of the first motor 212, a second motor position sensor 1328 of the second motor 214, and a third motor position sensor 1330 of the third motor 310. The motor position sensors 1326, 1328, 1330 may be position sensor(s) 810 discussed above.

The sensor interface 1318 may also control and/or receive data from one or more sensors of the UAV 100. The sensor interface 1318 may control and/or receive data from an accelerometer 1334, a geolocation sensor 1338, a gyroscope 1336, a barometer 1340, or a combination thereof of the UAV 100. All or some of the sensors of the UAV 100 may form the IMU of the UAV 100 discussed above. In some implementations, the accelerometer 1334 and the gyroscope 1336 may be combined as the inertial measurement unit (IMU).

The data controlled and/or received by the sensor interface 1318 may refer, for example, to one or more of temperature measurements, pressure measurements, a global positioning system (GPS) data, acceleration measurements, angular rate measurements, magnetic flux measurements, a visible spectrum image, an infrared image, an image including infrared data and visible spectrum data, and/or other sensor output. For example, the motor position sensors 1326, 1328, 1330 may generate data pertaining to a position of the motors 212, 214, 310 of the gimbal 150. In some implementations, the sensor interface 1318 may implement a serial port protocol (e.g., I2C or SPI) for communications with one or more sensor devices over conductors. In some implementations, the sensor interface 1318 may include a wireless interface for communicating with one or more sensor groups via low-power, short-range communications techniques (e.g., using a vehicle area network protocol).

The communications interface 1320 may facilitate communication with one or more other devices, for example, the UAV 100 or a system thereof, a controller (e.g., a first motor controller 1310, a second motor controller 1312, a third motor controller 1314, an image capture device controller 1316, or a combination thereof), or another device, for example, the user interface 930 (e.g., a smartphone, tablet, or other device). The controllers in communication with the communication interface 1320 may be configured to control operation of the motors 212, 214, 310 and the image capture device 130. The communications interface 1320 may include a wireless interface and/or a wired interface. For example, the wireless interface may facilitate communication via a Wi-Fi network, a Bluetooth link, a ZigBee link, or another network or link. In another example, the wired interface may facilitate communication via a serial port (e.g., RS-232 or USB). The communications interface 1320 may further facilitate communication via a network, which may, for example, be the Internet, a local area network, a wide area network, or another public or private network. Thus, the communications interface 1320 may be used to control operation of the motors 212, 214, 310 and the image capture device 130.

As discussed above, by way of example, the data storage device 1322 may be configured to store calibration data of the gimbal system 120. The communications interface 1320 may be configured to transmit the calibration data of the gimbal system 120 to the UAV 100. The communications interface 1320 may transmit the calibration data to a computing device 1332 of the UAV 100, whereby the computing device 1332 may adjust flight characteristics of the UAV 100 based upon the calibration data. For example, the computing device 1332 of the UAV 100 may include a communications interface that may control the propulsion mechanism(s) based on the calibration data transmitted from the gimbal system 120. The data storage device 1322 may be configured to store calibration data specific to the gimbal system 120 and may dynamically update the calibration data based upon operation of the gimbal system 120 (e.g., through data provided by the motor position sensors 1326, 1328, 1330).

To further illustrate communication between the gimbal system 120 and the UAV 100, initializing the gimbal system 120 will now be discussed in further detail. That is, when the gimbal system 120 is coupled to the UAV 100 (e.g., electrically and/or mechanically coupled to the UAV 100), the gimbal system 120 and/or the UAV 100 may complete an initialization process to prepare the gimbal system 120 and the UAV 100 for operation (e.g., flight and/or movement or use of the gimbal system 120).

Initialization of the gimbal system 120 and the UAV 100 may include calibrating the gimbal system 120 as described above with respect to FIGS. 10-12 to ensure that the gimbal system 120 properly operates once connected to the UAV 100. Additionally, as described above with respect to FIGS. 10-12, the UAV 100 may also be calibrated during initialization based on the calibration data stored on the computing device 412 of the gimbal system 120 being communicated to the UAV 100 (e.g., communicated to the computing device 1332 of the UAV 100) to modify or otherwise adjust flight characteristics and/or propulsion characteristics of the UAV 100.

Data (e.g., measurements) obtained by one or more of the components of the UAV 100 and/or one or more components of the gimbal system 120 may be utilized to initialize the gimbal system 120 and/or the UAV 100. For example, the gimbal system 120 may include an inertial measurement unit (IMU) 1342 that may be configured to measure and/or track a specific force, angular rate, magnetic field, or other parameters of the gimbal system 120. The IMU 1342 may include one or more components that are similar to the componentry of the UAV 100. That is, the UAV 100 may also include an IMU that is separate from the IMU 1342, which may include the accelerometer 1334, the gyroscope 1336, the barometer 1340, other sensors, or a combination thereof. As such the components of the shown in FIG. 13 UAV 100 may track or measure operation and/or positioning of the UAV 100 while the IMU 1342 and/or other components of the gimbal system 120 (e.g., the first motor position sensor 1326, the second motor position sensor 1328, and the third motor position sensor 1330) may track or measure operation and/or positioning of the gimbal system 120. That is, the various measurements obtained by the gimbal system 120 and the UAV 100 may be utilized to initialize the gimbal system 120 and the UAV 100 to ensure proper operation thereafter

To further illustrate, an example of initializing the gimbal system 120 will now be described. To initialize the gimbal system 120, data (e.g. measurements) obtained by the IMU 1342 of the gimbal system 120 and/or an IMU of the UAV 100 (e.g., the accelerometer 1334 and the gyroscope 1336) may be analyzed to determine a position of the gimbal system 120. For example, the IMU 1342 may provide accelerometer readings for the gimbal system 120 and the IMU of the UAV 100 may provide accelerometer readings for the UAV 100. Based on such data, a direction of gravity may be determined (e.g., determined by the computing device 412 of the gimbal system 120 and/or the computing device 1332 of the UAV 100), which may then be utilized to determine an altitude of the UAV 100. As the direction of gravity may only be a two degree of freedom measurement, full rotation (e.g., three degrees of freedom) may not yet be constrained without additional data.

Due to a high range of motion of the first motor 212, the second motor 214, and the third motor 310, a yaw axis may also need to be determined or otherwise accounted for to determine a full rotational position of the gimbal system 120 (i.e., a position of the image capture device 130 with three degrees of freedom), whereby the yaw axis may correspond to the elevational axis (Z) shown in FIG. 1. Data (e.g., measurements) obtained by the first motor position sensor 1326, the second motor position sensor 1328, and the third motor position sensor 1330 may be utilized to determine the yaw axis and further isolate positioning of the gimbal system 120 (e.g., positioning of the image capture device 130).

By way of example, as discussed above, the first motor position sensor 1326, the second motor position sensor 1328, and the third motor position sensor 1330 may each be or include a Hall effect sensor, whereby each of the sensors may determine an angle of each motor with respect to an axis of rotation of the motor (e.g., an angle of rotation of the first motor 212 with respect to the first axis of rotation (A), an angle of rotation of the second motor 214 with respect to the second axis of rotation (B), and an angle of rotation of the third motor 310 with respect to the third axis of rotation (C)). Such angles may determine a rotational position of the rotor of each motor with respect to their respective axis of rotation. However, due to such rotational positions being relative to a specific motor and potentially being based upon a finite number of possible angles (e.g., angles potentially detected by the position sensors based upon the number of magnets within the rotor of a given motor), positioning of rotational hard stops within each motor (e.g., the end stops 712) may also be implemented to more accurately determine the positions of each motor.

The rotational positions of each motor as described above may be used in conjunction with the measurements obtained by the IMU 1342 of the gimbal system 120 and/or the IMU of the UAV 100. Similarly, measurements from the IMU 1342 of the gimbal system 120 and/or the IMU of the UAV 100 may be utilized to initialize each of the position sensors (i.e., each of the motors) such that the position sensors may more accurately determine the position of each motor.

By way of example, readings from one or more of the position sensors may be combined to determine all possible positions (i.e., solutions) of a given motor. Each motor may have a certain number of possible positions based upon a configuration of the rotor of the motor (e.g., number of magnets within the rotor). Based on all possible positions, it may be determined (e.g., via the processor 1324) that one or more of the possible positions is in fact impossible based upon the true range of motion of a particular motor, which may be based on predefined parameters of the motor and/or based upon relative positioning of each of the motors that may constrain certain movements of a given motor.

Once the impossible positions are discarded from the analysis, each position (i.e., solution) may be evaluated to determine whether such a position may align with the current data (e.g., measurements) obtained by the IMU 1342 of the gimbal system 120 and/or the IMU of the UAV 100, which may be considered IMU readings. If a position aligns with the IMU readings, then it may be determined to be the correct (i.e., actual) position of the gimbal system 120. As such, the determined position may then be used as an initial starting position of the gimbal system 120 to begin calibrating the gimbal system 120 and/or to begin operation of the gimbal system 120.

However, due to variation in any particular gimbal system, further evaluation may be completed to increase the confidence in a determined position. By way of example, in certain configurations the yaw axis may be aligned perpendicular to the direction of gravity determined above. Based on such a position, it may not be possible to determine the motor angle with respect to the yaw axis. To further evaluate, the possible correct positions of the gimbal system 120 may be propagated using IMU data, such as measurements from the gyroscope 1336 of the UAV 100 and/or measurements from a gyroscope of the IMU 1342 of the gimbal system 120. This may help predict how such positions may change over time during operation of the UAV 100 and/or operation of the gimbal system 120. During such propagations, the possible correct positions may be analyzed to evaluate whether each of the positions is viable. Based on such evaluation, the correct position (i.e., the actual position) may be determined due to its significantly higher viability when compared to the remaining possible positions. As such, a significantly higher level of confidence with respect to the determined correct position may be achieved. Additionally, to avoid any further ambiguity, one or more of the motors may be rotated during this evaluation to ensure that one or more of the possible movements of the gimbal system 120 are not aligned (e.g., yaw and pitch axes aligned).

Once the position of each of the motors is determined based on the above, this information may be provided to the gimbal system 120 to begin calibration and/or operation. That is, the initializing process may accurately determine the position of each of the motors within the gimbal system 120 such that an initial starting position of the gimbal system 120 and thus the image capture device 130 may be determined. Similarly, the accurate determination of the position of each of the motors may also provide the user a finer control of movement of the gimbal system 120 when operating the gimbal system 120. That is, the user may articulate each of the arms of the gimbal system 120 more accurately based upon finer possible movement of each of the motors.

To further illustrate the above example of initializing, the present teachings may provide a method of initializing the gimbal system 120 of the UAV 100 to determine the initial position of the image capture device 130 coupled to the gimbal 150 of the gimbal system 120. The method may include obtaining, via the IMU 1342 of the gimbal system 120, measurements of one or more parameters of the gimbal system 120. The method may also include determining, based upon a measurement obtained by a position sensor (e.g., the first motor position 1326, the second motor position sensor 1328, or the third motor position sensor 1330) of the gimbal system 120, a rotational position of a motor (e.g., the first motor 212, the second motor 214, or the third motor 310) of the gimbal 150 with respect to an axis of rotation of the motor. Additionally, the method may include determining a possible position of the image capture device 130 based upon the rotational position of the motor and the one or more parameters. Responsive to determining the possible position, the method may also include determining whether the possible position is the initial position by comparing the possible position to the measurements, as described above.

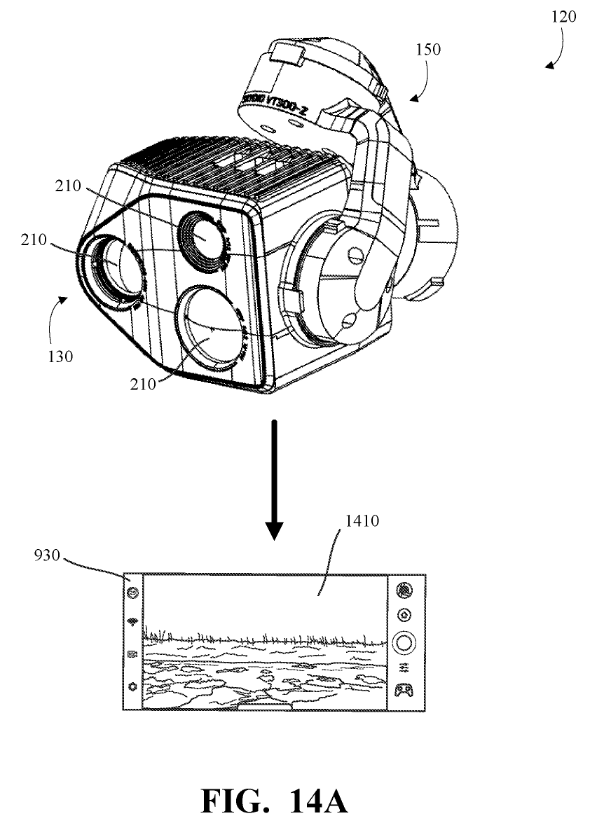

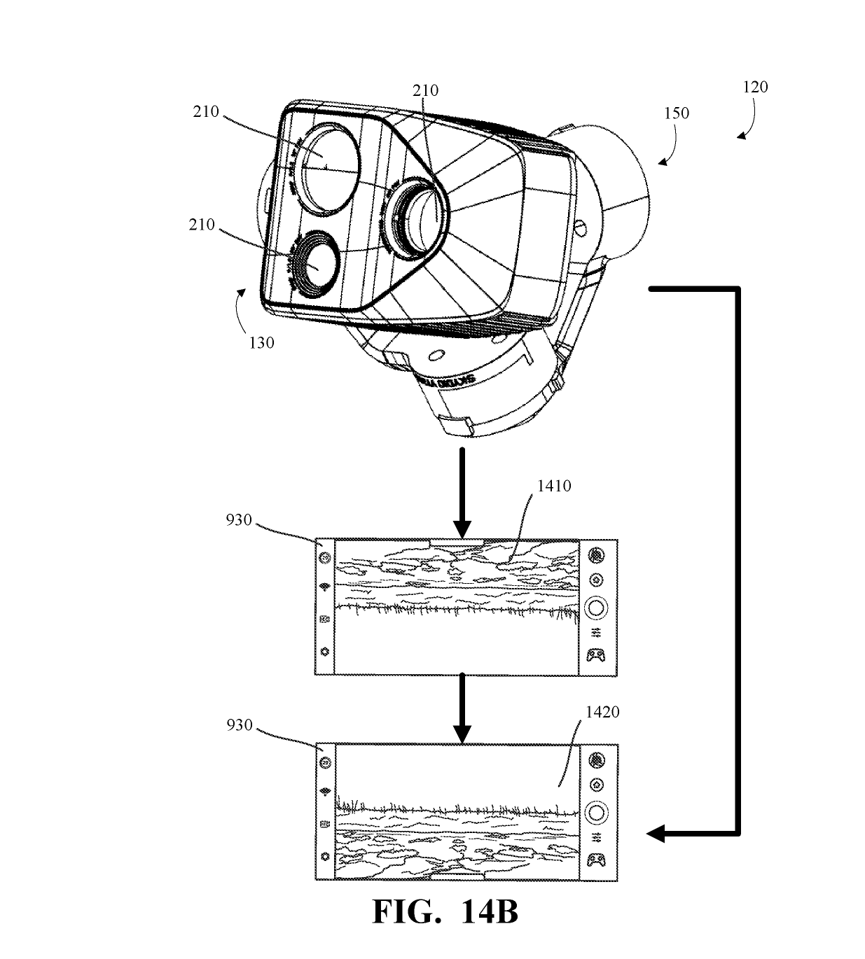

FIG. 14A and 14B illustrate perspective views of the gimbal system 120 of the UAV having the image capture device 130 in an upright position and a flipped position, respectively. The frame 140 of the gimbal system 120 has been removed for illustrative purposes. As shown, the image capture device 130 having one or more of the image sensors 210 may be movably coupled to the gimbal 150. The image capture device 130 may be configured to capture images and/or video. The images and/or video captured by the image capture device 130 may be transmitted as an image 1410 to the user interface 930 (e.g., an external device that may establish the user interface 930, such as through the network 910 with communication between the external device and the server 920). The image 1410 on the user interface 930 may be a live feed (e.g., video) provided by the image capture device 130 or may be a previously captured still image and/or video captured by the image capture device 130 (e.g., during a previous scan when the UAV 100 was in an initiated scan mode).

As shown in FIG. 14A, the image capture device 130 may be in the upright position, in which the image 1410 conveyed to the user interface 930 accurately depicts the image or video captured by the image capture device 130. The upright position of the image capture device 130 may be an initial or start position of the image capture device, whereby the image sensors 210 are orientated in a way that captures the image and/or video in a natural viewing position. For example, the image 1410 conveyed to the user interface 930 when the image capture device 130 is in the upright position illustrates the topography of a region scanned by the UAV 100. The ground shown in the image 1410 may be towards a bottom of the screen, whereby the image 1410 may be oriented in a manner that would correlate to the user physically walking viewing the same topography.

Conversely, when the image capture device 130 is in a flipped position, such as that shown in FIG. 14B, the image sensors 210 may be upside down, whereby the image 1410 conveyed to the user interface 930 would be oriented in a manner that is flipped with respect to the image 1410 conveyed when the image capture device 130 is in the upright position. That is, in the example discussed above, the topography captured would illustrate the ground as being along an upper edge of the user interface 930, whereby the image 1410 would be flipped substantially 180 degrees relative to a natural view of the image 1410 if the user were to naturally view the topography.

Advantageously, the present teachings may provide a correction of the image 1410 when the image capture device 130 is in the flipped position. For example, the position sensor(s) 810 of the gimbal system 120 or one or more additional sensors of the gimbal system 120 or the UAV 100 may actively determine the orientation of the image capture device 130 with respect to the UAV 100 and/or the ground. For example, an orientation of the image capture device 130 may be based upon an orientation of the UAV 100 and/or based upon an orientation of one or more of the motors of the gimbal 150. Measurements by the position sensor(s) 810 and/or the additional sensor(s) may be provided to the computing device 412 of the gimbal system 120. The computing device 412 may either directly or indirectly (e.g., through the UAV 100) communicate with the user interface 930 so that the image 1410 conveyed to the image capture device 130 is modified to be a corrected image 1420. As a result, the image 1410 initially transmitted to the user interface 930 may be flipped in orientation so that the corrected image 1420 may illustrate the image in a manner that would be more natural to the user of the user interface 930. It should be noted that the corrective measurements may not be limited to a substantially 180 degree flip of the image 1410. That is, any rotation or modification of the image 1410 may be possible based on the teachings herein.

The corrective action discussed above may also be implemented automatically during autonomous operation of the UAV 100, such as during the scan mode described above. That is, if the scan path established requires that the gimbal system 120 move at one or more points to the flipped position, during those moments along the scan path, the gimbal system 120 may be configured to automatically correct the image being captured so that a user may retrieve the image or view the image in live time (e.g., live video feed) with the corrected orientation of the image as needed.

It should be noted that flipping of the image 1410 to display the corrected image 1420 may be completed prior to, during, or after transmission to the user interface 930. For example, as discussed above, when the gimbal 150 is flipped and the image capture device 130 is located in the flipped position, the image 1410 may be initially transmitted to the user interface 930, at which point the image 1410 may be flipped by the user interface 930 to display the corrected image 1420. Additionally, or alternatively, such image correction may also be done prior to or during transmission of the image 1410 prior to the image 1410 being displayed by the user interface 930.

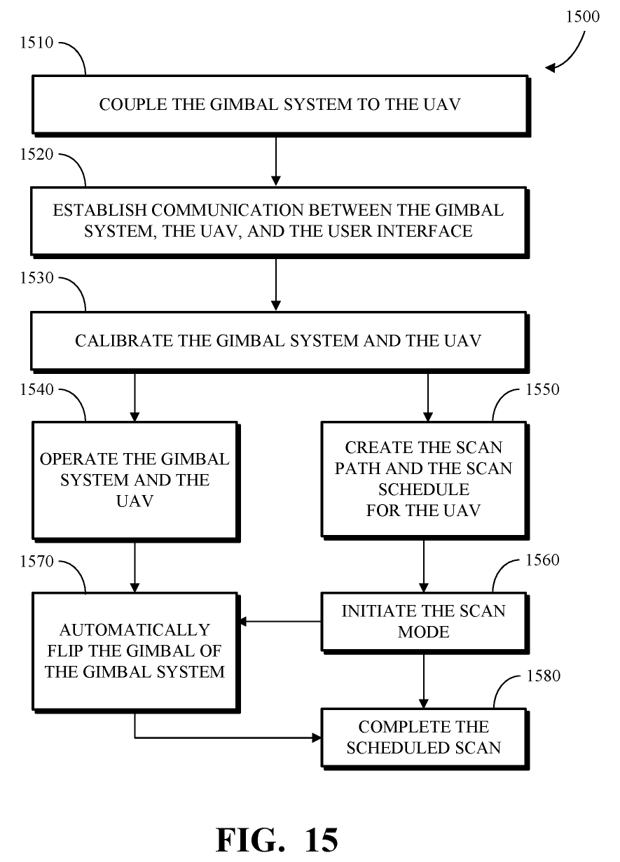

By way of example, in certain configurations, the image capture device 130 may be automatically flipped during operation of the UAV 100. For example, as discussed in further detail below with respect to FIG. 15, the gimbal system 120 may be configured to monitor a position and/or orientation of the image capture device 130 and automatically initiate flipping of the image capture device 130 to increase a range of motion of the image capture device 130. That is, the UAV 100 or a system thereof and/or the gimbal system 120 may actively monitor a position of the image capture device 130 and may automatically execute flipping of the image capture device 130 (e.g., flipping and/or articulation of one or more portions (e.g., motors) of the gimbal 150) when the image capture device 130 is prevented from articulating to a desired position based upon a constrained range of motion. Moreover, such flipping may also be executed automatically based upon a pre-defined routine, such as based upon a pre-defined scan path and/or scan schedule for a desired scan mode.

Based upon the active monitoring of the orientation and/or position of the image capture device 130, the image initially captured by the image capture device 130 (e.g., the image 1410) may be flipped or otherwise corrected prior to or during transmission to the user interface 930. For example, the UAV 100 and/or the gimbal system 150 may determine when flipping of the image capture device 130 occurs. Based upon such a determination, the UAV 100 (e.g., the computing device 1332 of the UAV 100) and/or the gimbal system 120 (e.g., the computing device 412 of the gimbal system 120) may responsively correct (e.g., flip) the image 1410 before the image 1410 is transmitted to the user interface 930 and/or before the image 1410 is displayed by the user interface 930. As a result, the user may only receive the corrected image 1420 in a seamless manner such that the user may never notice or recognize that the image being displayed by the user interface 930 is corrected or otherwise manipulated compared to the image being captured by the image capture device 130. Thus, in live-feed situations, the image being conveyed to user interface 930 for viewing by the user may be maintained with minimal or no interruption.

FIG. 15 illustrates a flowchart 1500 of an example of a process for operation a gimbal system of a UAV, such as the gimbal system 120 of the UAV 100. Initially at operation 1510, the gimbal system 120 may be removably coupled to the UAV 100 as discussed above. Communication between the gimbal system 120, the UAV 100, and the user interface 930 may then be established at operation 1520. Communication may be established similar to the operations 1020, 1130 discussed above. Once communication is established at the operation 1520, the gimbal system 120 and/or the UAV 100 may be calibrated at operation 1520. Calibration may be similar to the calibration completed at the operations 1030, 1140 discussed above. Calibration at operation 1530 may be or may include initialization of the gimbal system 120 as discussed above with respect to FIG. 13.

Once calibration at the operation 1530 is completed, the gimbal system 120 and the UAV 100 may be operated at operation 1540. That is, a user may initiate flight of the UAV 100 and operate (e.g., articulate) the gimbal system 120 during flight to capture one or more images using the image capture device 130. Such operation may be completed using the user interface 930.

Alternatively, once calibration at the operation 1530 is completed, a scan path and a scan schedule for the UAV 100 may be created at the operation 1550. The scan path and the scan schedule may be created using the user interface 930 and provided to the UAV 100 and/or the gimbal system 120. The scan path and the scan schedule may be similar to the scan path and the scan schedule created at operation 1240 discussed above. Based on the created scan path and scan schedule, the scan mode of the UAV 100 may be initiated at operation 1560 to begin autonomous operation of the UAV 100 and/or the gimbal system 120 along the created scan path based upon the created scan schedule. The scan mode of the UAV 100 may be initiated through the user interface 930 and may be completed at operation 1580.

During operation of the gimbal system 120 and the UAV 100, whether during manual operation of the UAV in operation 1540 or during the scan mode initiated at operation 1560, the gimbal system 120 may dynamically adjust a position of the of the gimbal 150 and/or one or more components thereof to ensure an optimized range of motion for the gimbal 150, thereby ensuring that the image capture device 130 accurately captures images within an optimized field of view. That is, the gimbal system 120 may dynamically monitor operation of the gimbal system 120 and the UAV 100 to determine a position of the gimbal system 120 and the image capture device 130 (e.g., based upon a determination similar to the initialization and/or calibration of the gimbal system 120 as discussed above) in real-time. Such information may then be utilized to make one or more adjustments to the gimbal system 120 during operation.

By way of example, the gimbal 150 of the gimbal system 120 may be automatically flipped during operation of the gimbal system 120 and the UAV 100 based upon the position information provided by the gimbal system 120 and/or the UAV 100 as discussed above (e.g., based upon information provided similar to the initialization process discussed above). At least one of the first motor 212, the second motor 214, and the third motor 310 may constrain a field of view and/or movement of the image capture device 130. For example, the first motor 212 may be configured to rotate in a clockwise or counterclockwise direction about 60 degrees or less, at which point further rotation is not possible. As a result, the image capture device 130 may be constrained to move only as much as the first motor 212 is able to rotate, thereby limiting the operation of the image capture device 130.

To combat such challenges, the gimbal system 120 may complete an automatic flip of the gimbal 150 at operation 1570. An automatic flip of the gimbal 150 may be considered an automatic articulation of one or more of the motors of the gimbal system 120 to rotate (e.g., flip) the position of the motor about 180 degrees such that the motor may thereafter provide an increased range of motion and thus provide the image capture device 130 an increased range of motion. It should be noted that a “flip” may also be considered any automatic adjustment of the position of one or more of the motors of the gimbal system 120 such that the gimbal 150 improves a range of motion of the image capture device 130. By way of example, such automatic flips may be similar to a movement between the position of the gimbal system 120 shown in FIG. 14A and the position of the gimbal system 120 shown in FIG. 14B (e.g., right-side up and upside-down, respectively).

Such automatic flips may be completed during manual operation of the gimbal system 120 and the UAV 100 or during the autonomous scan mode. Automatic flips or other articulation of the gimbal 150 may result in one or more of the arms of the gimbal 150 articulating to provide the increased range of motion of the image capture device 130. Additionally, it should be noted that while automated flipping of the gimbal 150 is described above, such flipping or other similar articulation (e.g., rotation of a motor greater than or less 180 degrees) may also be manually initiated by the user (e.g., via the user interface 930).

It should also be noted that automatic articulation or flipping of the gimbal 150 may be initiated based on any desired trigger. By way of example, certain predefined positions of one or more of the motors and/or the image capture device 130 may automatic initiated flipping of the gimbal 150 to increase the range of motion of the image capture device 130. Additionally, or alternatively, the gimbal system 120 and/or the UAV 100 may determine when the image capture device 130 is prevented from moving to a desired position to capture a portion of an environment. When such prevention occurs, the gimbal 150 may be automatically flipped or otherwise articulated to allow for the image capture device 130 to move to the desired position to capture the portion of the environment. Moreover, such determinations and operations may be completed by the computing device 412 of the gimbal system 120 and/or the computing device 1332 of the UAV 100.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180° ± 25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A system, comprising:
an unmanned aerial vehicle (UAV); and
a gimbal system removably coupled to the UAV and that includes:
an image capture device configured to capture an image of an environment based upon a range of motion of the image capture device;
a gimbal coupled to the image capture device and configured to articulate the image capture device, wherein the gimbal system is configured to automatically articulate the gimbal to increase a range of motion of the image capture device based upon one or more conditions; and
a computing device in communication with the image capture device and the gimbal to operate the image capture device and the gimbal.

2. The system of claim 1, wherein the gimbal system is configured to automatically articulate the gimbal when the image capture device reaches a predefined position.

3. The system of claim 1, wherein the gimbal includes a motor having a position sensor configured to determine a rotational position of the motor with respect to an axis of rotation, and the gimbal system is configured to automatically articulate the gimbal when the motor reaches a predefined position.

4. The system of claim 3, wherein the gimbal system is configured to automatically rotate the motor about 180 degrees with respect to the axis of rotation to flip the rotational position of motor and thereby increase the range of motion of the image capture device.

5. The system of claim 1, wherein the gimbal system is configured to automatically articulate the gimbal when the image capture device is prevented from reaching a desired position to capture the image of the environment.

6. The system of claim 1, wherein the computing device is configured to determine whether the one or more conditions for automatically articulating the gimbal are met.

7. The system of claim 1, further comprising a remote electronic device configured to communicate with the computing device to display the image captured by the image capture device.

8. The system of claim 7, wherein a user is configured to initiate automatically articulating the gimbal via the remote electronic device.

9. The system of claim 7, wherein the remote electronic device or at least one of the UAV and the gimbal system prior is configured to automatically flip the image approximately 180 degrees when the gimbal system automatically articulates the gimbal.

10. The system of claim 1, wherein the UAV is configured to operate autonomously to complete a scan mode, and the gimbal system is configured to automatically articulate the gimbal during the autonomous operation.

11. A system, comprising:
an unmanned aerial vehicle (UAV) configured for autonomous flight based upon a predefined scan path and a predefined scan schedule; and
a gimbal system removably coupled to the UAV and that includes:
an image capture device configured to articulate based upon a range of motion;
a gimbal coupled to the image capture device and configured for automatic articulation by the gimbal system during autonomous flight of the UAV to increase the range of motion of the image capture device; and
a computing device in communication with the image capture device and the gimbal to operate the image capture device and the gimbal,
wherein responsive to the gimbal system automatically articulating the gimbal, at least one of the UAV and the computing device is configured to correct an image captured by the image capture device prior to transmitting the image to a remote electronic device that is configured to display the image.

12. The system of claim 11, wherein the remote electronic device is configured to communicate with the computing device to display the image on a display of the remote electronic device.

13. The system of claim 12, wherein at least one of the UAV and the computing device is configured to correct an orientation of the image transmitted to the remote electronic device when the gimbal system automatically articulates the gimbal.

14. The system of claim 13, wherein at least one of the UAV and the computing device is configured to correct the image by modifying an orientation of the image displayed by the remote electronic device prior to the remote electronic device displaying the image.

15. The system of claim 14, wherein the gimbal system is configured to automatically rotate the image capture device approximately 180 degrees about an axis of rotation, and at least one of the UAV and the computing device is configured to rotate the image approximately 180 degrees in response to rotating the image capture device.

16. The system of claim 11, wherein the gimbal system is configured to determine an orientation of the image capture device based upon data captured by a position sensor of the gimbal.

17. The system of claim 16, wherein the data captured by the position sensor is a rotational position of a motor of the gimbal, and the orientation of the image capture device is based upon the rotational position of the motor.

18. A system, comprising:
an unmanned aerial vehicle (UAV);
a gimbal system removably coupled to the UAV and that includes:
an image capture device configured to capture an image;
a gimbal coupled to the image capture device and configured to articulate the image capture device, wherein the gimbal system is configured to automatically articulate the gimbal to move the image capture device from an upright position, in which the image capture device captures the image in a natural viewing position, to a flipped position, in which the image capture device is rotated about 180 degrees with respect to an axis of rotation; and
a computing device removably coupled and electrically connected to the UAV; and
a remote electronic device in wireless communication with at least one of the UAV and the gimbal system and configured to display the image,
wherein responsive to the gimbal system automatically articulating the gimbal to move the image capture device from the upright position to the flipped position, the remote electronic device is configured to rotate the image in real-time when displaying the image such that the image is displayed as if the image were captured in the natural viewing position.

19. The gimbal system of claim 18, wherein the image is a video configured for displaying as a live feed by the remote electronic device, and rotation of the image is done in real-time such that a user viewing the image on the remote electronic device is unable to notice the rotation of the image.

20. The gimbal system of claim 19, wherein the computing device includes a communication interface configured to transmit an orientation of the image capture device to the remote electronic device, and the remote electronic device is configured to rotate the image based upon receiving the orientation of the image capture device.
